(19) United States
(12) Patent Application Publication
(10) Pub. No.: US 2024/0292452 A1
(43) Pub. Date: Aug. 29, 2024

(54) METHODS AND ARRANGEMENTS FOR PROTECTION OF INTELLIGENT TRANSPORT SYSTEM CHANNELS

(71) Applicant: Intel Corporation, Santa Clara, CA (US)

(72) Inventors: Markus Dominik Mueck, Unterhaching (DE); John Roman, Hillsboro, OR (US)

(73) Assignee: Intel Corporation, Santa Clara, CA (US)

(21) Appl. No.: 18/399,391

(22) Filed: Dec. 28, 2023

(51) Int. Cl. H04W 74/0808; H04L 5/00

(52) U.S. Cl. CPC H04W 74/0808; H04L 5/0044

(57) ABSTRACT

Logic to protect intelligent transportation system (ITS) communications from interference by communications on neighboring channel by actions of an ITS device, by actions of a wireless communications device on a neighboring channel, or a combination thereof. Logic to perform clear channel assessment (CCA) on a neighbor channel, the neighbor channel outside an allocation for ITS channels; cause transmission of a physical layer protocol data unit (PPDU) comprising a network allocation vector (NAV) in the neighbor channel, the PPDU to identify the neighbor channel as busy for a period of time to allocate for ITS communications; monitor an ITS channel for ITS communications to determine if the ITS channel is busy; and perform ITS communications within the period of time on the ITS channel after a determination that the ITS channel is not busy. And logic to monitor a neighbor channel and perform an operation to protect the neighbor channel.

### BACKGROUND

In 1999, the Federal Communications Commission (FCC) reserved 75 megahertz in the 5.9 gigahertz (GHz) band (5.850-5.925 GHZ) for Intelligent Transportation System (ITS) services based on Dedicated Short-Range Communications (DSRC) technology. In December 2019, the Commission initiated a Notice of Proposed Rulemaking to take a fresh look at the 5.9 GHz with the proposal (1) to repurpose 45 megahertz of spectrum in the 5.850-5.895 GHz band for unlicensed use and allow immediate access for unlicensed indoor operations across the 5.850-5.895 GHz band and (2) to require ITS technology to operate only in the 5.895-5.925 GHz band. The existing ITS band plan contains three, 10-megahertz channels: channels 180, 182, and 184 corresponding to 5.895-5.905, 5.905-5.915 and 5.915-5.925 GHz, respectively.

Considering that the ITS communications may include critical vehicular communications for autonomous and semi-autonomous communications, the operation of unlicensed WiFi communications in neighboring channels may present disadvantageous interference.

### BRIEF DESCRIPTION OF THE DRAWINGS

FIG. 1A depicts a system diagram illustrating an embodiment of a network environment for protect logic circuitry, in accordance with one or more example embodiments.

FIG. 1B depicts an embodiment Intelligent Transportation System (ITS) channels and neighbor channels.

FIG. 1C depicts an embodiment of a system including multiple MLDs operating on Wi-Fi channels and multiple ITS devices operating on ITS channels, in accordance with one or more example embodiments.

FIG. 1D illustrates an embodiment of a radio architecture for STAs, such as the wireless interfaces for STAs and ITS devices depicted in FIGS. 1A-C, to implement protect logic circuitry.

FIG. 1E illustrates an embodiment of front-end module (FEM) circuitry of a wireless interface for STAs and ITS devices, such as the STAs in FIGS. 1A-C, to implement protect logic circuitry.

FIG. 1F illustrates an embodiment of radio integrated circuit (IC) circuitry of a wireless interface for STAs and ITS devices, such as the STAs in FIGS. 1A-C, to implement protect logic circuitry.

FIG. 1G illustrates an embodiment of baseband processing circuitry of a wireless interface for STAs and ITS devices, such as the STAs in FIGS. 1A-C, to implement protect logic circuitry.

FIG. 2A depicts an embodiment of transmissions between four stations and an AP on Wi-Fi communications channels.

FIG. 2B depicts an embodiment of a transmission between one station and an AP on Wi-Fi communications channels.

FIG. 2C depicts an embodiment of a resource units on Wi-Fi communications channels.

FIG. 2D depicts an embodiment of a multiple user (MU) physical layer (PHY) protocol data unit (PPDU).

FIG. 2E depicts another embodiment of a MU PPDU comprising a data field for a MAC management frame.

FIG. 2F depicts an embodiment of a physical layer service data unit (PDSU) comprising a MAC management frame such as shown in FIGS. 2G-I.

FIGS. 2G-2H depict embodiments of a PPDU with a MAC control frame that may be transmitted by an ITS device to a STA such as an AP STA of an AP MLD, or vice vera.

FIG. 3 depicts an embodiment of a wireless communications interface with protect logic circuitry such as the wireless communications interfaces shown in FIG. 1C.

FIG. 4A depicts an embodiment of a flowchart for an ITS device to implement protect logic circuitry such as the protect logic circuitry discussed in conjunction with FIGS. 1-3.

FIG. 4B depicts another embodiment of a flowchart for a STA such as a Wi-Fi device to implement protect logic circuitry such as the protect logic circuitry discussed in conjunction with FIGS. 1-3.

FIGS. 4C-D depict embodiments of flowcharts to generate and transmit frames and receive and interpret frames for communications between wireless communication devices.

FIG. 5 depicts an embodiment of a functional diagram of a wireless communication device, in accordance with one or more example embodiments of the present disclosure.

FIG. 6 depicts an embodiment of a block diagram of a machine upon which any of one or more techniques may be performed, in accordance with one or more embodiments.

FIGS. 7-8 depict embodiments of a computer-readable storage medium and a computing platform to implement protect logic circuitry.

### DETAILED DESCRIPTION OF EMBODIMENTS

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

One of the objectives of embodiments is how to protect 5.9 GHZ vehicular (Intelligent Transport Systems ITS) and one of the objectives of one of the more specific embodiments discussed herein is how to protect ITS channel 180 from the unlicensed systems operating on channel 178 (formerly of an ITS channel, which is adjacent to the ITS channel 180.

Currently, the approach is to switch the 5.9 GHZ vehicular system to a very robust MCS (Modulation and Coding mode) to cope with Wi-Fi interference. The issue is that then the overall capacity and spectral efficiency for 5.9 GHz operation is reduced dramatically. A very robust MCS can reduce the effects of interference, but will still be impaired by the de-sensitization due to the wide band noise from the interference by wireless communications both below ITS channels and above ITS channels, which results in reduced receiver (RX) sensitivity, and thus reduced range.

Embodiments may introduce solutions to ensure that unlicensed systems (including WiFi) leave neighboring channels that may produce interference e.g., the neighbor channels of the current ITS channels 180, 182, and 184, or other channels that may be allocated to ITS services unused while an ITS system is operating proximate to Wi-Fi (or 3GPP NR-unlicensed) to minimize out-of-band emissions into the ITS channels communications. Some embodiments may specifically introduce solutions to ensure that unlicensed systems (including WiFi) leave channel 178 (i.e., the neighboring channel just next to channel 180) unused while an ITS system is present to minimize out-of-band emissions into the lower ITS channel 180 communication as strong interference from Wi-Fi (or 3GPP NR-unlicensed).

Some embodiments may include protect logic circuitry in stations (STAs) such as Wi-Fi STAs, user equipment (UE), Wi-Fi or cellular base stations or radio access nodes (RANs), ITS devices, or a combination thereof, to implement a time division of use ITS channels and neighbor Wi-Fi channels or 3GPP NR-unlicensed channels or cause the STAs to move communications, at least temporarily to more distant channels. In some embodiments, protect logic circuitry may cause the STAs to pause communications in neighbor channels of ITS channels or switch from wideband channels to narrower band channels to reduce emissions in one or more of the ITS channels.

In some embodiments, for specific protection of channel 180 (used by ITS services) against interference caused by unlicensed systems operating in channel 178, protect logic circuitry in STAs may cause such STAs to move to communications from channel 178 to one of the channels below channel 178 or pause or delay communications in channel 178 while ITS services communicate at the same time and in geographic proximity on channel 180.

Various embodiments may be designed to address different technical problems associated with interference from neighbor channels on ITS channels such as how to maintain ITS communications when communications are present in neighbor channels that may cause interference; determining how to address interference from neighbor channels without unnecessarily reducing the operating range of the ITS communications; how to address wideband communications in neighbor channels of ITS channels; and/or the like.

Different technical problems such as those discussed above may be addressed by one or more different embodiments. Embodiments may address one or more of these problems associated with interference in the form of emissions from communications in neighbor channels of ITS channels. For instance, some embodiments that address problems associated with interference may do so by one or more different technical means, such as, detecting energy of communications in a neighbor channel of one or more ITS channels; detecting beacon frame transmissions in a neighbor channel of one or more ITS channels; decoding a preamble of communications in a neighbor channel of one or more ITS channels; causing transmission of a physical layer protocol data unit (PPDU) comprising a network allocation vector (NAV) in the neighbor channel, the PPDU to identify the neighbor channel as busy for a period of time to allocate for ITS communications; monitoring the neighbor channel by performance of energy detection in the neighbor channel; detecting a preamble on the neighbor channel; receiving and decoding a communication on the neighbor channel; allocating a more distant channel from the ITS channels while communications are present on the ITS channels; delaying communications on a neighbor channel of ITS channels during ITS communications on one or more of the ITS channels; allocating a narrower bandwidth channel for communications on a channel neighboring one or more ITS channels; and/or the like.

Some embodiments may associate links of more than one stations (STAs) of multi-link devices (MLDs). Links may be established (or logical) communications channels or connections between MLDs. MLDs include more than one stations (STAs). For instance, an access point (AP) MLD and a non-AP MLD may both include STAs configured for multiple frequency bands such as a first STA configured for 2.4 gigahertz (GHz) communications, a second STA configured for 5 GHz communications, and a third STA configured for 6 GHz communications.

In many embodiments discussed herein, MLDs have STAs operating on the same set of carrier frequencies but MLDs are not limited to STAs with any particular set of carrier frequencies. For example, embodiments may comprise MLDs that have a set of STAs operating on one or more overlapping carrier frequencies such as STAs with carrier frequencies in a range of sub 1 GHz, 1 GHz to 7.25 GHz, 7.25 GHz to 45 GHZ, above 45 GHz, around 60 GHz, and/or the like. In some embodiments, standard power STAs may be able to operate on 5.925-6.425 GHZ and 6.525-6.875 GHz portions of the 6 GHz channel.

Note that Wi-Fi STAs may be AP STAs or non-AP STAs and may each be associated with a specific link of an MLD. Note also that an MLD can include AP functionality in one or more STAs for one or more links and, if a Wi-Fi STA of the MLD operates as an AP on a link, the STA is referred to as an AP STA. If the Wi-Fi STA does not perform AP functionality, or does not operate as an AP, on a link, the Wi-Fi STA is referred to as a non-AP STA. In many of the embodiments herein, the AP MLDs operate as AP STAs on active links, and the non-AP MLDs operate as non-AP STAs on active links. However, an AP MLD may also have STAs that operate as non-AP STAs on the same extended service set (ESS) or basic service set (BSS) or other ESS's or BSS's.

Embodiments may also comprise protect logic circuitry to facilitate communications for any of the radio links described herein according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP Rel. 19 (3rd Generation Partnership Project Release 19) and subsequent Releases (such as Rel. 20, Rel. 21, etc.), 3GPP 5G, 5G, 3GPP 6G, 6G, 6th Generation Cellular Networks, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, and Bluetooth®.

Any of the radio links described herein may further operate according to any one or more of the following radio communication technologies and/or standards including but not limited to: stations such as Radio Local Area Networks (RLAN), Institute of Electrical and Electronics Engineers (IEEE) 802.11 standards for wireless communications (generally referred to as “Wi-Fi”) such as IEEE 802.11-220 December 2020; IEEE P802.11az™/D3.0, IEEE P802.11ba-2021™, IEEE P802.11bb™/D0.4, IEEE P802.11bc™/D1.02; IEEE 802.11b (Wi-Fi 1) and/or IEEE 802.11a (Wi-Fi 2) and/or IEEE 802.11g (Wi-Fi 3) and/or 802.11n (Wi-Fi 4) and/or IEEE 802.11ac (Wi-Fi 5) and/or IEEE P802.11ax-2021™ (Wi-Fi 6) and/or IEEE P802.11bc™/D2.2, October 2022 (Wi-Fi 7) and/or any follow-up Wi-Fi related technology), Wireless Gigabit Alliance (WiGig) standard, mmWave standards in general (wireless systems operating at 10-300 GHz and above such as WiGig, IEEE 802.11ad, IEEE P802.11ay-2021™, etc.), technologies operating above 300 GHz and THz bands, (3GPP/LTE based or IEEE 802.11p or IEEE P802.11bd™/D1.1, and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHZ)), DSRC in Japan in the 700 MHz band (including 715 MHz to 725 MHZ), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHZ, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHZ, 902-928 MHZ (note: allocated for example in US (FCC Part 15)), 863-868.6 MHz (note: allocated for example in European Union (EU) (ETSI EN 300 220)), 915.9-929.7 MHZ (note: allocated for example in Japan), 917-923.5 MHz (note: allocated for example in South Korea), 755-779 MHz and 779-787 MHZ (note: allocated for example in China), 790-960 MHz, 1710-2025 MHz, 2110-2200 MHZ, 2300-2400 MH2, 2.4-2.4835 GHz (note: it is an ISM band with global availability and it is used by Wi-Fi technology family (11b/g/n/ax) and also by Bluetooth), 2500-2690 MHz, 698-790 MHZ, 610-790 MH2, 3400-3600 MHZ, 3400-3800 MHZ, 3800-4200 MHZ, 3.55-3.7 GHZ (note: allocated for example in the US for Citizen Broadband Radio Service), 5.15-5.25 GHZ and 5.25-5.35 GHZ and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHz, 31-31.3 GHZ, 37-38.6 GHz, 38.6-40 GHz, 42-42.5 GHZ, 57-64 GHZ, 71-76 GHZ, 81-86 GHZ and 92-94 GHz, etc.), the ITS (Intelligent Transport Systems) band of 5.9 GHZ (typically 5.85-5.925 GHZ) and 63-64 GHZ, bands currently allocated to WiGig such as WiGig Band 1 (57.24-59.40 GHZ), WiGig Band 2 (59.40-61.56 GHZ) and WiGig Band 3 (61.56-63.72 GHZ) and WiGig Band 4 (63.72-65.88 GHZ), 57-64/66 GHZ (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHZ-71 GHz band, any band between 65.88 GHz and 71 GHz, bands currently allocated to automotive radar applications such as 76-81 GHZ, and future bands including 94-300 GHZ and above. Furthermore, the scheme can be used on a secondary basis on bands such as the TV White Space bands (typically below 790 MHZ) where in particular the 400 MHz and 700 MHZ bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g. by introducing a hierarchical prioritization of usage for different types of users (e.g., low/medium/high priority, etc.), based on a prioritized access to the spectrum e.g. with highest priority to tier-1 users, followed by tier-2, then tier-3, etc. users, etc.

Aspects described herein can also be applied to different Single Carrier (SC) or orthogonal frequency division multiplexing (OFDM) flavors (cyclic prefix (CP) CP-OFDM, SC-FDMA (frequency division multiple access), SC-OFDM, filter bank-based multicarrier (FBMC), orthogonal frequency division multiple access (OFDMA), etc.) and in particular 3GPP NR (New Radio) by allocating the OFDM carrier data bit vectors to the corresponding symbol resources.].

Some of the features in this document are defined for the network side, such as Access Points (APs), evolved NodeBs (eNodeBs), New Radio (NR) or next generation Node Bs (gNodeB or gNB—note that this term is typically used in the context of 3GPP fifth generation (5G) communication systems), etc. Still, a User Equipment (UE) may take this role as well and act as an Access Points, eNodeBs, gNodeBs, etc. Some or all features defined for network equipment may be implemented by a UE.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

Several embodiments comprise central servers, access points (APs), and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, and the like), and the like.

Some embodiments may facilitate wireless communications in accordance with multiple standards. Some embodiments may comprise low power wireless communications like Bluetooth®, cellular communications, and messaging systems. Furthermore, some wireless embodiments may incorporate a single antenna while other embodiments may employ multiple antennas or antenna elements.

While some of the specific embodiments described below will reference the embodiments with specific configurations, those of skill in the art will realize that embodiments of the present disclosure may advantageously be implemented with other configurations with similar issues or problems.

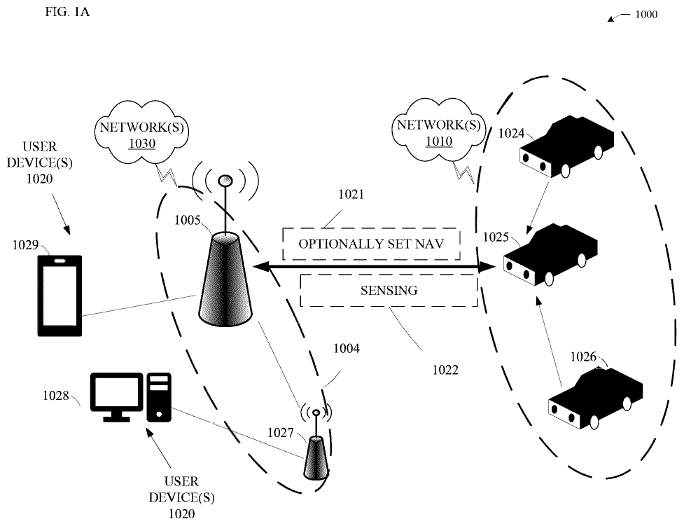

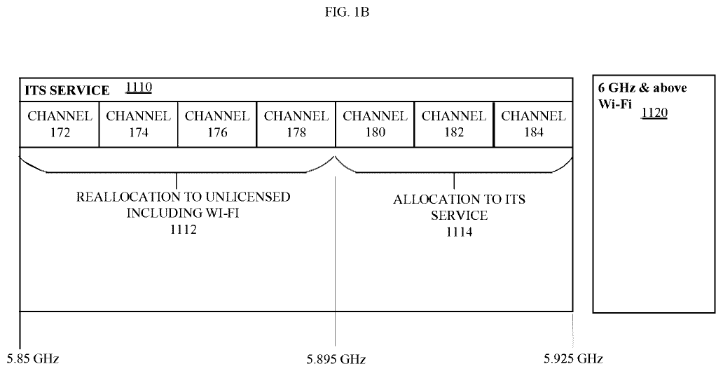

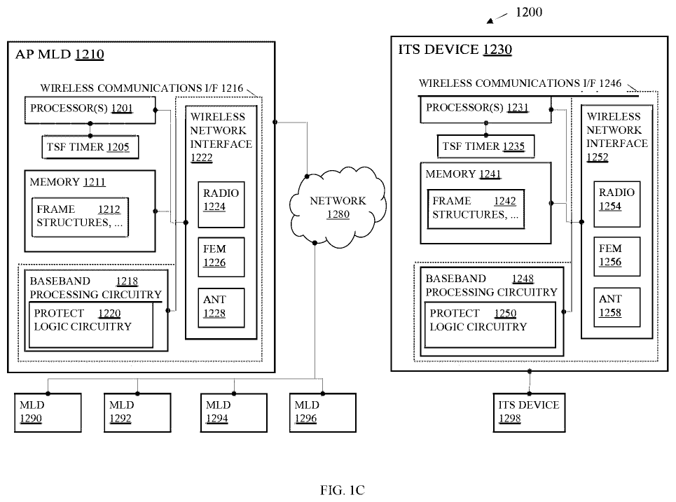

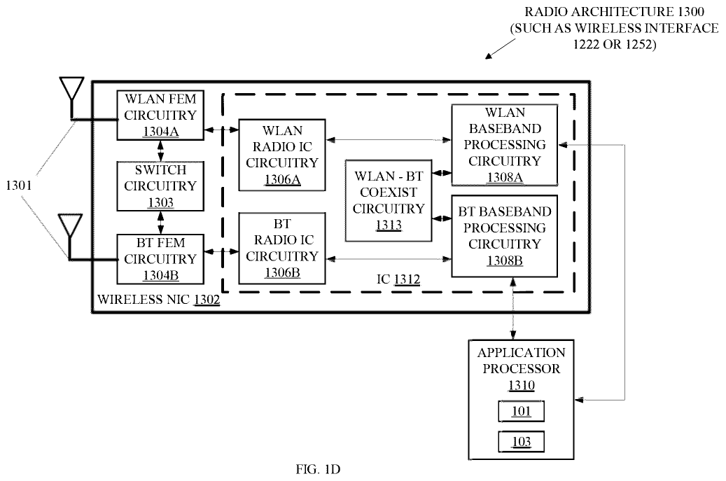

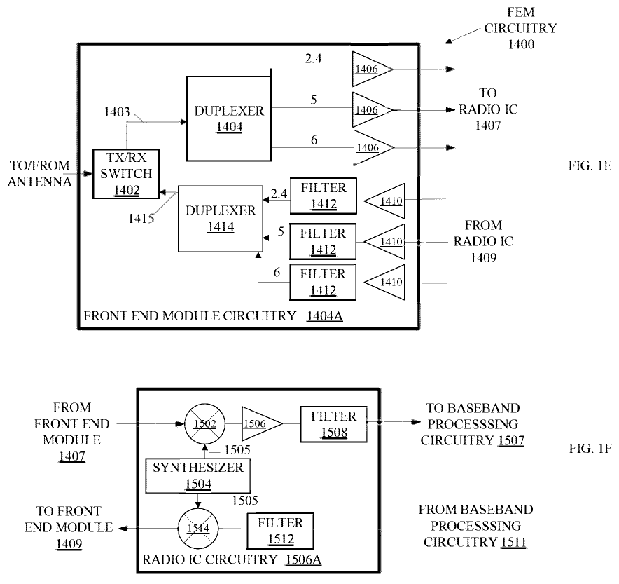

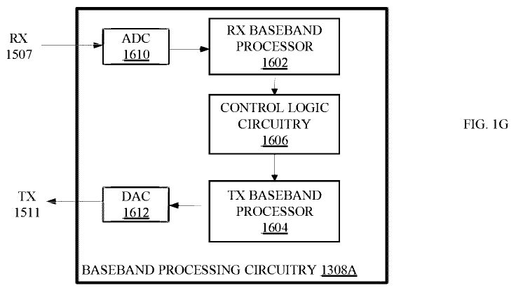

FIG. 1A depicts a system diagram illustrating an embodiment of a network environment 1000 for protect logic circuitry, in accordance with one or more example embodiments. Wireless network 1010 may include a mobile network with ITS services for V2V and V2X communications between ITS devices 1024, 1025, and 1026. In some embodiments, the ITS devices 1024, 1025, and 1026 may comprise autonomous or semi-autonomous vehicles with a requirement for critical V2V and/or V2X communications for safety reasons.

Wireless network 1030 may include a base station 1005 such as a cellular radio access node (RAN), which may communicate in accordance with 3GPP technical specifications and a base station 1027 such as an AP STA and/or a cellular UE, which may communicate in accordance with IEEE 802.11 communication standards and/or 3GPP technical specifications with the base station 1005 as well as one or more user device(s) 1020. In some embodiments, user device(s) 1020 such as a smart phone 1029 and a computer 1028 may communicate with the base station 1005 and/or the base stations 1027.

In the present embodiment, the base station 1005 may perform communications on one or more channels that are neighbor channels of ITS channels and the ITS devices 1024, 1025, and 1026 may enter a geographical area in proximity to the wireless network 1030. After entering the geographical area, the base station 1005 may comprise protect logic circuitry that may detect the network 1010 via one or more mechanisms. For instance, the protect logic circuitry of the base station 1005 may perform sensing 1022 such as energy detection periodically, sporadically, or continuously in one or more ITS channels associated with the networks 1010. The protect logic circuitry of the base station 1005 may capture energy from the ITS channels and compare the captured energy to a threshold energy level indicative of communications in the one or more ITS channels. After detection of an energy level greater than or equal to a threshold for communications in the one or more ITS channels, the protect logic circuitry of the base station 1005 may determine to perform an operation to protect the ITS channels at least until a period of time has passed without any detection of energy on the ITS channels. In some embodiments, the period of time may be a predetermined delay period. For instance, the period of time may be within a range of 30 milliseconds to ten minutes, 10 milliseconds to 30 milliseconds, 20 milliseconds to 45 milliseconds, 1 second to 3 seconds, 2 seconds to 4 seconds, 1 minute, or the like. The larger period of time may advantageously reduce the chance causing interference to the ITS channels. The smaller periods of time may advantageously reduce congestion in communications performed by the base station 1005.

In some embodiments, the protect logic circuitry of the base station 1005 may, in addition to energy detection, perform sensing 1022 such as detecting a preamble of an ITS communication in one or more of the ITS channels prior to the protect logic circuitry of the base station 1005 performing an operation to protect the one or more ITS channels. Such embodiments may advantageously reduce the incidence of mistakenly performing an operation to protect one or more of the ITS channels when no ITS communications are actually present on the ITS channels.

In further embodiments, the protect logic circuitry of the base station 1005 may, in addition to energy detection, perform sensing 1022 such as detecting a specific type of periodic communication performed in V2V or V2X communications for ITS services prior to the protect logic circuitry of the base station 1005 performing an operation to protect the one or more ITS channels. For instance, the protect logic circuitry of the base station 1005 may perform an autocorrelation on the (known) header of the ITS signal (either ITS-G5/DSRC/C-V2X/NR-V2X/etc.). The autocorrelation may generate a peak value if the header is detected and thus the presence of an ITS communication is identified. Alternatively, the protect logic circuitry of the base station 1005 may receive and decode the ITS communication and if the decoding is successful (for example identified through some Cyclic Redundance Check or other check sum), the presence of an ITS communication is identified. Such embodiments may advantageously reduce the incidence of mistakenly performing an operation to protect one or more of the ITS channels when no ITS communications are actually present on the ITS channels.

After determining that ITS communications are present on the ITS channels, the protect logic circuitry of the base station 1005 may perform the operation to protect the ITS channels. For instance, the operation may comprise pausing or delaying communications on one or more channels that neighbor the one or more ITS channels. In some embodiments, the protect logic circuitry of the base station 1005 may pause or delay communications on channel 178 after a determination that communications are present on ITS channel 180. In some embodiments, the protect logic circuitry of the base station 1005 may pause or delay communications on the channel 178 after a determination that communications are present on ITS channels 180 or 182, or on channels 180, 182, or 184. In some embodiments, the protect logic circuitry of the base station 1005 may pause or delay communications on the channel 178 and/or pause or delay communications on a one or more subchannels of a 6 GHz channel between 5.925 GHz and 6 GHz.

In some embodiments, after detection of ITS communications, the protect logic circuitry of the base station 1005 may pause or delay communications on the pause or delay such communications for the predetermined delay period discussed above after communications are no longer detected on the one or more ITS channels.

In some embodiments, after detection of ITS communications, the protect logic circuitry of the base station 1005 may, after one or more pauses or delays or in lieu of a pause or delay, allocate a more distant channel for communications currently allocated for a neighboring channel of the ITS channels. For instance, the protect logic circuitry of the base station 1005 may allocate channel 176 (or channel 174 or channel 170 or lower channel) for communications currently being performed in channel 178 after detection of an ITS communication in ITS channel 180 (or in any one or more of the ITS channels). Furthermore, some embodiments may allocate communications in one or more subchannels of the 6 GHz band from subchannels proximate to the ITS channels to channels more distant from the ITS channels after detection of ITS communications in ITS channel 184, in ITS channel 184 and/or ITS channel 182, or any of the ITS channels.

In some embodiments, the protect logic circuitry of the base station 1005 may perform an operation to protect the ITS channels by changing an allocation for a wideband channel in the 6 GHz band to a narrower bandwidth channel in the 6 GHz band. For instance, the protect logic circuitry of the base station 1005 may change an allocation for a 320 MHz channel to a 160 MHZ channel, an 80 MHz channel, a 40 MHz channel, or a 20 MHz channel. Note that the wider bandwidth channels may cause higher power density emissions in neighboring ITS channels than lower bandwidth channels so changing an allocation from a wider bandwidth channel to a narrower bandwidth channel may advantageously reduce interference in one or more of the ITS channels.

In some embodiments, the protect logic circuitry of the base station 1005 may perform an operation to protect the ITS channels by reducing transmission power of communications in one or more channels proximate to the ITS channels such as reducing transmission power in channel 178, channel 176, channel 174, and/or reducing power in a channel or one or more subchannels in the 6 GHz band.

In some embodiments, the ITS devices 1024, 1025, and/or 1026 may comprise protect logic circuitry in addition to or in lieu of inclusion of protect logic circuitry in the base station 1005. In such embodiments, the protect logic circuitry of, e.g., the ITS device 1025 may perform sensing 1022 periodically, sporadically, or continuously in one or more neighbor channels such as channel 178, channel 176, and/or one or more 6 GHz channels or sub-channels. In some embodiments, the protect logic circuitry of, e.g., the ITS device 1025 may perform sensing 1022 such as energy detection. If the energy detected in one or more of the neighboring channels is greater than or equal to a threshold energy, which indicates the presence of a communication, the protect logic circuitry of, e.g., the ITS device 1025 may perform one or more operations.

In some embodiments, the protect logic circuitry of, e.g., the ITS device 1025 may perform sensing 1022 such as a preamble detection via autocorrelation. In some embodiments, the protect logic circuitry of, e.g., the ITS device 1025 may perform sensing 1022 such as receiving and decoding a frame such as a beacon frame. A successful reception of the beacon frame may advantageously identify a communication as well as provide information such as an address for an AP STA or a cellular RAN. In some embodiments, the protect logic circuitry of, e.g., the ITS device 1025 may further cause transmission of a request to the AP STA or the cellular RAN to request that the AP STA or the cellular RAN attenuate transmission power of communications in one or more neighbor channels of the ITS channels and/or prevent communications within one or more channels for a vacate time period by, e.g., reallocating communications in the one or more neighboring channels to more distant channels from the ITS channels. In other embodiments, the protect logic circuitry of, e.g., the ITS device 1025 may further cause transmission of communications that cause interference in channels that neighbor the ITS channels to encourage communications in the one or more neighboring channels to be reallocated to more distant channels from the ITS channels.

In some embodiments, the one or more operations may protect the ITS communications by reallocating communications in, e.g., an ITS channel 180 to an ITS channel 182 and/or an ITS channel 184 to move the communications to an ITS channel more distant from the potential source of interference after detection of communications in one or more of channel 178, channel 176, or channel 174. In some embodiments, the one or more operations may protect the ITS communications by reallocating communications in, e.g., an ITS channel 184 to an ITS channel 182 and/or an ITS channel 180 to move the communications to an ITS channel more distant from the potential source of interference after detection of communications in the 6 GHZ band or in one or more subbands of the 6 GHz band.

In some embodiments, the one or more operations may protect the ITS communications by causing transmission of a physical layer (PHY) protocol data unit (PPDU) comprising a NAV 1021 in one or more of the neighboring channels outside of the ITS channels. In some embodiments, the ITS device 1025 may comprise one or more precoded PPDUs stored in memory for one or more different channels and/or one or more different communications protocols or specifications to set a NAV 1021 for a predetermined period of time. The predetermined period of time may comprise a period of time required to perform one or more ITS communications between the ITS devices 124, 125, and/or 126.

In some embodiments, in lieu of sensing 1022, the protect logic circuitry of, e.g., the ITS device 1025 may perform one or more operations to reduce interference from neighboring channels. For instance, the protect logic circuitry of, e.g., the ITS device 1025 may preemptively cause transmission of a PPDU comprising a NAV 1021 in one or more of the neighboring channels outside of the ITS channels such as in channel 178, channel 176, channel 174 and/or in a 6 GHZ channel or one or more subchannels of the 6 GHz channel. In other embodiments, the protect logic circuitry of, e.g., the ITS device 1025 may cause transmission of communications to preemptively cause interference in channels that neighbor the ITS channels to encourage communications in the one or more neighboring channels, if the communications are present, to be reallocated to more distant channels from the ITS channels.

In some embodiments, the user device(s) 1020 and/or base stations 1005 and 1027 may include any suitable processor-driven device including, but not limited to, a mobile device or a non-mobile, e.g., a static device. For example, user device(s) 1020 and/or base stations 1005 and 1027 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless network interface, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

In some embodiments, the user device(s) 1020 and/or base stations 1005 and 1027 may also include mesh stations in, for example, a mesh network, in accordance with one or more IEEE 802.11 standards and/or 3GPP standards.

Any of the user device(s) 1020, the ITS devices 1024, 1025, and 1026, and base stations 1005 and 1027 may be configured to communicate with each other via one or more communications networks 1030 wirelessly or wired. In some embodiments, the user device(s) 1020 may also communicate peer-to-peer or directly with each other with or without the base stations 1005 and 1027 and, in some embodiments, the user device(s) 1020 may also communicate peer-to-peer if enabled by the base stations 1005 and 1027.

In some embodiments, the communications network 1030 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, the communications network 1030 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 1030 and/or 1035 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

In some embodiments, the user device(s) 1020 the ITS devices 1024, 1025, and 1026, and base stations 1005 and 1027 may include one or more communications antennas. The one or more communications antennas may be any suitable type of antennas corresponding to the communications protocols used by the user device(s) 1020, the ITS devices 1024, 1025, and 1026, and base stations 1005 and 1027. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 1020, the ITS devices 1024, 1025, and 1026, and base stations 1005 and 1027.

Any of the user device(s) 1020, the ITS devices 1024, 1025, and 1026, and base stations 1005 and 1027 may be configured to wirelessly communicate in a wireless network. Any of the user device(s) 1020, the ITS devices 1024, 1025, and 1026, and base stations 1005 and 1027 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 1020, the ITS devices 1024, 1025, and 1026, and base stations 1005 and 1027 may be configured to perform any given directional transmission towards one or more defined transmit sectors. Any of the user device(s) 1020, the ITS devices 1024, 1025, and 1026, and base stations 1005 and 1027 may be configured to perform any given directional reception from one or more defined receive sectors.

MIMO beamforming in a wireless network may be accomplished using RF beamforming and/or digital beamforming. In some embodiments, in performing a given MIMO transmission, user devices 1020, the ITS devices 1024, 1025, and 1026, and base stations 1005 and 1027 may be configured to use all or a subset of its one or more communications antennas to perform MIMO beamforming.

Any of the user devices 1020, the ITS devices 1024, 1025, and 1026, and base stations 1005 and 1027 may include any suitable radio and/or transceiver for transmitting and/or receiving radio frequency (RF) signals in the bandwidth and/or channels corresponding to the communications protocols utilized by any of the user device(s) 1020, the ITS devices 1024, 1025, and 1026, and base stations 1005 and 1027 to communicate with each other. The radio components may include hardware and/or software to modulate and/or demodulate communications signals according to pre-established transmission protocols. The radio components may further have hardware and/or software instructions to communicate via one or more cellular, Wi-Fi and/or Wi-Fi direct protocols, as standardized by the IEEE 802.11 standards and/or 3GPP technical specifications discussed herein. In some embodiments, non-Wi-Fi protocols and/or non-3GPP protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a power amplifier (PA), a low noise amplifier (LNA), additional signal amplifiers, an analog-to-digital (A/D) converter, one or more buffers, and a digital baseband.

FIG. 1B depicts an embodiment Intelligent Transportation System (ITS) channels and neighbor channels. The ITS service 1110 illustrates the frequency range of channels that were allocated to the ITS services by the FCC including the channels 172, 174, 176, and 178 (5.85 GHZ to 5.895 GHZ) that are reallocated to unlicensed services 1112 such as Wi-Fi, and the channels 180, 182, and 184 (5.895 GHz to 5.925 GHZ) that are currently allocated for ITS service 1114. The 6 GHz Wi-Fi channels neighbor the channels allocated to ITS service 1114 and the reallocated ITS service channels to unlicensed neighbor the channels allocated to ITS service 1114.

FIG. 1C depicts an embodiment of a system 1200 including multiple MLDs 1210, 1290, 1292, 1294, and 1296 operating on Wi-Fi channels and multiple ITS devices 1230 and 1298 operating on ITS channels, in accordance with one or more example embodiments. AP MLD 1210 may transmit or receive as well as generate, decode, and interpret transmissions between an AP MLD 1210 and multiple MLDs 1210, 1290, 1292, 1294, and 1296, associated with the AP MLD 1210. The AP MLD 1210 may be wired and/or wirelessly connected to each of the MLDs 1290, 1292, 1294, and 1296. MLD 1296 may be allocated a channel neighboring ITS channels such as channel 178 or a 6 GHz channel near 5.925 GHz that has an 80 MHz bandwidth.

ITS devices 1230 and 1298 may be vehicles, may comprise protect logic circuitry such as protect logic circuitry 1250 to perform operations such as scanning neighboring channels and/or proactively transmitting PPDUs on neighboring channels to protect the ITS channels and particularly to protect ITS channels on which the ITS devices 1230 and 1298 are communicating. In the present embodiment, the ITS device 1230 and the ITS device 1298 may communicate over an edge ITS channel such as channel 180 or channel 184. The ITS devices 1230 and 1298 may be in motion and may arrive in the geographical area of AP MLD 1210. In some embodiments, the ITS devices 1230 and 1298 may preemptively determine to cause transmission of a PPDU comprising a NAV on one or more neighboring channels such as channel 178 and one or more neighboring 6 GHz channels prior to attempting to communication. In some embodiments, the ITS devices 1230 and/or 1298 may scan the neighboring channels via energy detection to determine whether communications exist on the neighboring channels prior to causing transmission of the PPDU on any of the neighboring channels. In some embodiments, after detecting energy on one of the neighboring channels such as channel 178 and not detecting energy on the 6 GHz channels or subchannels, the protect logic circuitry 1250 of ITS device 1230 may trigger a move or hand/over from ITS channel 180 to ITS channel 182 or ITS channel 184 for communications between ITS devices 1230 and 1298.

In some embodiments, after detection of energy in channel 178, the protect logic circuitry 1250 of ITS device 1230 may monitor the channel 178 for a known preamble via autocorrelation or may attempt to receive and decode a communication such as a beacon frame from channel 178 and, in the process, identify the AP STA associated with the communications in the channel 178. In response to receiving and decoding a beacon frame from AP MLD 1210, the protect logic circuitry 1250 of the ITS device 1230 may generate and transmit a request to the AP MLD 1210 such as a request to allocate a different channel (other than channel 178) more distant from the ITS channels for communication with MLD 1296. In further embodiments, the protect logic circuitry 1250 of ITS device 1230 may also or alternatively generate and cause transmission of a request to the AP MLD 1210 to reduce transmission power for any communications within channel 178. In further embodiments, the protect logic circuitry 1250 of ITS device 1230 may also or alternatively generate and cause transmission of a request to the AP MLD 1210 to narrow a bandwidth for any communications within channel 178.

In some embodiments, the AP MLD 1210 and possibly each of the MLDs 1290, 1292, 1294, and 1296 may comprise protect logic circuitry such as protect logic circuitry 1220. The protect logic circuitry 1220 of AP MLD 1210 may actively scan for communications in ITS channels prior to communications on channels neighboring the ITS channels, periodically, sporadically, or continuously. Prior to receipt of a PPDU from the ITS device 1230, the AP MLD 1210 may detect energy in the ITS channel 180 that is above a threshold for indication of communications. In some embodiments, based on the energy detection above the threshold, the AP MLD 1210 may perform operations to protect the ITS channels from interference from communications ongoing in channel 178, channel 176, and one or more 6 GHz channels. In some embodiments, for instance, the protect logic circuitry 1220 of AP MLD 1210 may move or hand/over communications between AP MLD 1296 and AP MLD 1210 in channel 178 to channel 174. Similarly, the AP MLD 1210 may allocate resources for communications with MLD 1298 into channel 174 and may, in some embodiments, reduce transmission power for all communications in channel 174. In further embodiments, the AP MLD 1210 may narrow bandwidths of communications associated with channels neighboring the ITS channels.

In other embodiments, the protect logic circuitry 1220 may reduce transmission power for communications in channels adjacent to the ITS channels and may attempt to verify an existence of preamble of an ITS communication in one or more of the ITS channels prior to moving communications with the MLD 1296 to a more distance channel from the ITS channels. For instance. The protect logic circuitry 1220 may detect energy above a threshold in the ITS channel 180 and may perform protective operations of reducing transmission power for communications in channels neighboring the ITS channels. The protect logic circuitry 1220 may concurrently attempt to detect a known preamble in the ITS communications via autocorrelation of the known preamble for a common communication and energy received from any one or more of the ITS channels. Upon determining a peak value during the autocorrelation, the protect logic circuitry 1220 may allocate resources in the channel 174 for the communications between the AP MLD 1210 and the MLD 1296 currently in channel 178 as well as for the communications between AP MLD 1210 and MLD 1294 currently in channel 176.

The AP MLD 1210 and IT device 1230 may comprise processor(s) 1201 and memory 1231, respectively. The processor(s) 1201 may comprise any data processing device such as a microprocessor, a microcontroller, a state machine, and/or the like, and may execute instructions or code in the memory 1211. The memory 1211 may comprise a storage medium such as Dynamic Random Access Memory (DRAM), read only memory (ROM), buffers, registers, cache, flash memory, hard disk drives, solid-state drives, or the like. The memory 1211 may store the frames, frame structures, frame headers, etc., 1212 and may also comprise code to generate, scramble, encode, decode, parse, and interpret MAC frames and/or PHY frames and physical layer protocol data units (PPDUs).

The baseband processing circuitry 1218 may comprise a baseband processor and/or one or more circuits to implement an MLD station management entity (MM-SME) and a station management entity (SME) per link. The MM-SME may coordinate management of, communications between, and interactions between SMEs for the links.

In some embodiments, the SME may interact with a MAC layer management entity to perform MAC layer functionality and a PHY management entity to perform PHY functionality. In such embodiments, the baseband processing circuitry 1218 may interact with processor(s) 1201 to coordinate higher layer functionality with MAC layer and PHY functionality.

In some embodiments, the baseband processing circuitry 1218 may interact with one or more analog devices to perform PHY functionality such as scrambling, encoding, modulating, and the like. In other embodiments, the baseband processing circuitry 1218 may execute code to perform one or more of the PHY functionality such as scrambling, encoding, modulating, and the like.

The MAC layer functionality may execute MAC layer code stored in the memory 1211. In further embodiments, the MAC layer functionality may interface the processor(s) 1201. Furthermore, the memory 1211 may store known preambles and/or packets for ITS communications such that the processor(s) 1201 and/or the baseband processing circuitry 1218 may autocorrelate energy detected in ITS channels with the known preambles and/or packets for ITS communications to verify the existence of communications in the ITS channels.

The MAC layer functionality may communicate with the PHY via the SME to transmit a MAC frame such as a multiple-user (MU) ready to send (RTS), referred to as a MU-RTS, in a PHY frame such as an extremely high throughput (EHT) MU PPDU to the MLD 1230. The MAC layer functionality may generate frames such as management, data, and control frames.

The PHY may prepare the MAC frame for transmission by, e.g., determining a preamble to prepend to a MAC frame to create a PHY frame. The preamble may include one or more short training field (STF) values, long training field (LTF) values, and signal (SIG) field values. A wireless network interface 1222 or the baseband processing circuitry 1218 may prepare the PHY frame as a scrambled, encoded, modulated PPDU in the time domain signals for the radio 1224. Furthermore, the TSF timer 1205 may provide a timestamp value to indicate the time at which the PPDU is transmitted.

After processing the PHY frame, a radio 1225 may impress digital data onto subcarriers of RF frequencies for transmission by electromagnetic radiation via elements of an antenna array or antennas 1224 and via the network 1280 to a receiving MLD STA of a MLD such as the MLD 1296.

The wireless network I/F 1222 also comprises a receiver. The receiver receives electromagnetic energy, extracts the digital data, and the analog PHY and/or the baseband processor 1218 decodes a PHY frame and a MAC frame from a PPDU.

The ITS device 1230 may receive an ITS communication from ITS device 1298 and/or a Wi-Fi or cellular communication from the AP MLD 1210 or MLD 1296 via the network 1280. The ITS device 1230 may comprise processor(s) 1231 and memory 1241. The processor(s) 1231 may comprise any data processing device such as a microprocessor, a microcontroller, a state machine, and/or the like, and may execute instructions or code in the memory 1241. The memory 1241 may comprise a storage medium such as Dynamic Random Access Memory (DRAM), read only memory (ROM), buffers, registers, cache, flash memory, hard disk drives, solid-state drives, or the like. The memory 1241 may store 1242 the frames, frame structures, frame headers, etc., and may also comprise code to generate, scramble, encode, decode, parse, and interpret MAC frames and/or PHY frames (PPDUs). In some embodiments, the memory may comprise one or more precoded PPDUs of one or more different bandwidths for transmission on neighboring channels to the ITS channels such that the ITS device 1230 may pass the precoded PPDU to a PHY of the ITS device 1230 to cause transmission of the PPDU via the wireless interface 1246.

The baseband processing circuitry 1248 may comprise a baseband processor and/or one or more circuits to perform MAC layer functionality to perform PHY functionality. In such embodiments, the baseband processing circuitry 1248 may interact with processor(s) 1231 to coordinate higher layer functionality with MAC layer and PHY functionality.

In some embodiments, the baseband processing circuitry 1218 may interact with one or more analog devices to perform PHY functionality such as descrambling, decoding, demodulating, and the like. In other embodiments, the baseband processing circuitry 1218 may execute code to perform one or more of the PHY functionalities such as descrambling, decoding, demodulating, and the like.

The ITS device 1230 may detect energy and/or receive an ITS communication packet, a Wi-Fi PPDU, or a cellular frame at the antennas 1258, which pass the signals along to the FEM 1256. The FEM 1256 may amplify and filter the signals and pass the signals to the radio 1254. The radio 1254 may filter the carrier signals from the signals and determine if the signals represent a communication. If so, analog circuitry of the wireless network I/F 1252 or physical layer functionality implemented in the baseband processing circuitry 1248 may demodulate, decode, descramble, etc. the communication. In some embodiments, the baseband processing circuitry 1248 may identify, parse, and interpret the communication such as a MAC service data unit (MSDU) from the physical layer service data unit (PSDU) of a PPDU, an ITS communication packet, or a cellular frame.

FIG. 1D is an embodiment of a block diagram of a radio architecture 1300 such as the wireless communications I/F 1222 and 1252 in accordance with some embodiments that may be implemented in, e.g., the AP MLD 1210 and/or the ITS device 1230 of FIG. 1C. The radio architecture 1300 may include radio front-end module (FEM) circuitry 1304a-b, radio IC circuitry 1306a-b and baseband processing circuitry 1308a-b. The radio architecture 1300 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1304a-b may include a WLAN or Wi-Fi FEM circuitry 1304a and a Bluetooth (BT) FEM circuitry 1304b. The WLAN FEM circuitry 1304a may include a receive signal path comprising circuitry configured to operate on WLAN RF signals received from one or more antennas 1301, to amplify the received signals and to provide the amplified versions of the received signals to the WLAN radio IC circuitry 1306a for further processing. The BT FEM circuitry 1304b may include a receive signal path which may include circuitry configured to operate on BT RF signals received from one or more antennas 1301, to amplify the received signals and to provide the amplified versions of the received signals to the BT radio IC circuitry 1306b for further processing. FEM circuitry 1304a may also include a transmit signal path which may include circuitry configured to amplify WLAN signals provided by the radio IC circuitry 1306a for wireless transmission by one or more of the antennas 1301. In addition, FEM circuitry 1304b may also include a transmit signal path which may include circuitry configured to amplify BT signals provided by the radio IC circuitry 1306b for wireless transmission by the one or more antennas. In the embodiment of FIG. 1D, although FEM 1304a and FEM 1304b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1306a-b as shown may include WLAN radio IC circuitry 1306a and BT radio IC circuitry 1306b. The WLAN radio IC circuitry 1306a may include a receive signal path which may include circuitry to down-convert WLAN RF signals received from the FEM circuitry 1304a and provide baseband signals to WLAN baseband processing circuitry 1308a. BT radio IC circuitry 1306b may in turn include a receive signal path which may include circuitry to down-convert BT RF signals received from the FEM circuitry 1304b and provide baseband signals to BT baseband processing circuitry 1308b. WLAN radio IC circuitry 1306a may also include a transmit signal path which may include circuitry to up-convert WLAN baseband signals provided by the WLAN baseband processing circuitry 1308a and provide WLAN RF output signals to the FEM circuitry 1304a for subsequent wireless transmission by the one or more antennas 1301. BT radio IC circuitry 1306b may also include a transmit signal path which may include circuitry to up-convert BT baseband signals provided by the BT baseband processing circuitry 1308b and provide BT RF output signals to the FEM circuitry 1304b for subsequent wireless transmission by the one or more antennas 1301. In the embodiment of FIG. 1D, although radio IC circuitries 1306a and 1306b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1308a-b may include a WLAN baseband processing circuitry 1308a and a BT baseband processing circuitry 1308b. The WLAN baseband processing circuitry 1308a may include a memory, such as, for example, a set of RAM arrays in a Fast Fourier Transform or Inverse Fast Fourier Transform block (not shown) of the WLAN baseband processing circuitry 1308a. Each of the WLAN baseband circuitry 1308a and the BT baseband circuitry 1308b may further include one or more processors and control logic to process the signals received from the corresponding WLAN or BT receive signal path of the radio IC circuitry 1306a-b, and to also generate corresponding WLAN or BT baseband signals for the transmit signal path of the radio IC circuitry 1306a-b. Each of the baseband processing circuitries 1308a and 1308b may further include physical layer (PHY) and medium access control layer (MAC) circuitry, and may further interface with a device for generation and processing of the baseband signals and for controlling operations of the radio IC circuitry 1306a-b.

Referring still to FIG. 1D, according to the shown embodiment, WLAN-BT coexistence circuitry 1313 may include logic providing an interface between the WLAN baseband circuitry 1308a and the BT baseband circuitry 1308b to enable use cases requiring WLAN and BT coexistence. In addition, a switch circuitry 1303 may be provided between the WLAN FEM circuitry 1304a and the BT FEM circuitry 1304b to allow switching between the WLAN and BT radios according to application needs. In addition, although the antennas 1301 are depicted as being respectively connected to the WLAN FEM circuitry 1304a and the BT FEM circuitry 1304b, embodiments include within their scope the sharing of one or more antennas as between the WLAN and BT FEMs, or the provision of more than one antenna connected to each of FEM 1304a or 1304b.

In some embodiments, the front-end module circuitry 1304a-b, the radio IC circuitry 1306a-b, and baseband processing circuitry 1308a-b may be provided on a single radio card, such as wireless network interface card (NIC) 1302. In some other embodiments, the one or more antennas 1301, the FEM circuitry 1304a-b and the radio IC circuitry 1306a-b may be provided on a single radio card. In some other embodiments, the radio IC circuitry 1306a-b and the baseband processing circuitry 1308a-b may be provided on a single chip or integrated circuit (IC), such as IC 1312.

In some embodiments, the wireless NIC 1302 may include a WLAN radio card and may be configured for Wi-Fi communications, although the scope of the embodiments is not limited in this respect. In some of these embodiments, the radio architecture 1300 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 1300 may be part of a Wi-Fi communication station (STA) such as a wireless access point (AP), a base station or a mobile device including a Wi-Fi device. In some of these embodiments, radio architecture 1300 may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2020, IEEE 802.11ay-2021, IEE 802.11ba-2021, IEEE 802.11ax-2021, and/or IEEE 802.11be standards and/or proposed specifications for WLANs, although the scope of embodiments is not limited in this respect. The radio architecture 1300 may also be suitable to transmit and/or receive communications in accordance with other techniques and standards.

In some embodiments, the radio architecture 1300 may be configured for high-efficiency Wi-Fi (HEW) communications in accordance with the IEEE 802.11ax-2021 standard. In these embodiments, the radio architecture 1300 may be configured to communicate in accordance with an OFDMA technique, although the scope of the embodiments is not limited in this respect.

In some other embodiments, the radio architecture 1300 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1D, the BT baseband circuitry 1308b may be compliant with a Bluetooth (BT) connectivity specification such as Bluetooth 5.0, or any other iteration of the Bluetooth specification.

In some embodiments, the radio architecture 1300 may include other radio cards, such as a cellular radio card configured for cellular (e.g., 5GPP such as LTE, LTE-Advanced or 7G communications).

In some IEEE 802.11 embodiments, the radio architecture 1300 may be configured for communication over various channel bandwidths including bandwidths having center frequencies of about 2.4 GHz, 5 GHZ, and 6 GHz. The various bandwidths may include bandwidths of about 20 MH2, 40 MHz, 80 MHz, 160 MHZ, 240 MHz, and 320 MHz with contiguous or non-contiguous bandwidths having increments of 20 MHz, 40 MHz, 80 MHZ, 160 MHZ, 240 MHZ, and 320 MHZ. The scope of the embodiments is not limited with respect to the above center frequencies, however.

FIG. 1E illustrates FEM circuitry 1400 such as WLAN FEM circuitry 1304a shown in FIG. 1 D in accordance with some embodiments. Although the example of FIG. 1E is described in conjunction with the WLAN FEM circuitry 1304a, the example of FIG. 1E may be described in conjunction with other configurations such as the BT FEM circuitry 1304b.

In some embodiments, the FEM circuitry 1400 may include a TX/RX switch 1402 to switch between transmit mode and receive mode operation. The FEM circuitry 1400 may include a receive signal path and a transmit signal path. The receive signal path of the FEM circuitry 1400 may include a low-noise amplifier (LNA) 1406 to amplify received RF signals 1403 and provide the amplified received RF signals 1407 as an output (e.g., to the radio IC circuitry 1306a-b (FIG. 1D)). The transmit signal path of the circuitry 1304a may include a power amplifier (PA) to amplify input RF signals 1409 (e.g., provided by the radio IC circuitry 1306a-b), and one or more filters 1412, such as band-pass filters (BPFs), low-pass filters (LPFs) or other types of filters, to generate RF signals 1415 for subsequent transmission (e.g., by one or more of the antennas 1301 (FIG. 1D)) via an example duplexer 1414.

In some dual-mode embodiments for Wi-Fi communication, the FEM circuitry 1400 may be configured to operate in the 2.4 GHz frequency spectrum, the 5 GHz frequency spectrum, or the 6 GHz frequency spectrum. In these embodiments, the receive signal path of the FEM circuitry 1400 may include a receive signal path duplexer 1404 to separate the signals from each spectrum as well as provide a separate LNA 1406 for each spectrum as shown. In these embodiments, the transmit signal path of the FEM circuitry 1400 may also include a power amplifier 1410 and a filter 1412, such as a BPF, an LPF or another type of filter for each frequency spectrum and a transmit signal path duplexer 1404 to provide the signals of one of the different spectrums onto a single transmit path for subsequent transmission by the one or more of the antennas 1301 (FIG. 1D). In some embodiments, BT communications may utilize the 2.4 GHZ signal paths and may utilize the same FEM circuitry 1400 as the one used for WLAN communications.

FIG. 1F illustrates radio IC circuitry 1506a in accordance with some embodiments. The radio IC circuitry 1306a is one example of circuitry that may be suitable for use as the WLAN or BT radio IC circuitry 1306a/1306b (FIG. 1D), although other circuitry configurations may also be suitable. Alternatively, the example of FIG. 1F may be described in conjunction with the example BT radio IC circuitry 1306b.

In some embodiments, the radio IC circuitry 1306a may include a receive signal path and a transmit signal path. The receive signal path of the radio IC circuitry 1306a may include at least mixer circuitry 1502, such as, for example, down-conversion mixer circuitry, amplifier circuitry 1506 and filter circuitry 1508. The transmit signal path of the radio IC circuitry 1306a may include at least filter circuitry 1512 and mixer circuitry 1514, such as, for example, up-conversion mixer circuitry. Radio IC circuitry 1306a may also include synthesizer circuitry 1504 for synthesizing a frequency 1505 for use by the mixer circuitry 1502 and the mixer circuitry 1514. The mixer circuitry 1502 and/or 1514 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 1F illustrates only a simplified version of a radio IC circuitry, and may include, although not shown, embodiments where each of the depicted circuitries may include more than one component. For instance, mixer circuitry 1514 may each include one or more mixers, and filter circuitries 1508 and/or 1512 may each include one or more filters, such as one or more BPFs and/or LPFs according to application needs. For example, when mixer circuitries are of the direct-conversion type, they may each include two or more mixers.

In some embodiments, mixer circuitry 1502 may be configured to down-convert RF signals 1407 received from the FEM circuitry 1304a-b (FIG. 1D) based on the synthesized frequency 1505 provided by synthesizer circuitry 1504. The amplifier circuitry 1506 may be configured to amplify the down-converted signals and the filter circuitry 1508 may include an LPF configured to remove unwanted signals from the down-converted signals to generate output baseband signals 1507. Output baseband signals 1507 may be provided to the baseband processing circuitry 1308a-b (FIG. 1D) for further processing. In some embodiments, the output baseband signals 1507 may be zero-frequency baseband signals, although this is not a requirement. In some embodiments, mixer circuitry 1502 may comprise passive mixers, although the scope of the embodiments is not limited in this respect.

In some embodiments, the mixer circuitry 1514 may be configured to up-convert input baseband signals 1511 based on the synthesized frequency 1505 provided by the synthesizer circuitry 1504 to generate RF output signals 1409 for the FEM circuitry 1304a-b. The baseband signals 1511 may be provided by the baseband processing circuitry 1308a-b and may be filtered by filter circuitry 1512. The filter circuitry 1512 may include an LPF or a BPF, although the scope of the embodiments is not limited in this respect.

In some embodiments, the mixer circuitry 1502 and the mixer circuitry 1514 may each include two or more mixers and may be arranged for quadrature down-conversion and/or up-conversion respectively with the help of synthesizer 1504. In some embodiments, the mixer circuitry 1502 and the mixer circuitry 1514 may each include two or more mixers each configured for image rejection (e.g., Hartley image rejection). In some embodiments, the mixer circuitry 1502 and the mixer circuitry 1514 may be arranged for direct down-conversion and/or direct up-conversion, respectively. In some embodiments, the mixer circuitry 1502 and the mixer circuitry 1514 may be configured for super-heterodyne operation, although this is not a requirement.

Mixer circuitry 1502 may comprise, according to one embodiment: quadrature passive mixers (e.g., for the in-phase (I) and quadrature phase (Q) paths). In such an embodiment, RF input signal 1407 from FIG. 1F may be downconverted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1505 of synthesizer 1504 (FIG. 1F). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1407 (FIG. 1E) may comprise a balanced signal, although the scope of the embodiments is not limited in this respect. The I and Q baseband output signals may be provided to low-noise amplifier, such as amplifier circuitry 1506 (FIG. 1F) or to filter circuitry 1508 (FIG. 1F).

In some embodiments, the output baseband signals 1507 and the input baseband signals 1511 may be analog baseband signals, although the scope of the embodiments is not limited in this respect. In some alternate embodiments, the output baseband signals 1507 and the input baseband signals 1511 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1504 may be a fractional-N synthesizer or a fractional N/N+1 synthesizer, although the scope of the embodiments is not limited in this respect as other types of frequency synthesizers may be suitable. For example, synthesizer circuitry 1504 may be a delta-sigma synthesizer, a frequency multiplier, or a synthesizer comprising a phase-locked loop with a frequency divider. According to some embodiments, the synthesizer circuitry 1504 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1504 may be provided by a voltage-controlled oscillator (VCO), although that is not a requirement. A divider control input may further be provided by either of the baseband processing circuitry 1308a-b (FIG. 1D) depending on the desired output frequency 1505. In some embodiments, a divider control input (e.g., N) may be determined from a look-up table (e.g., within a Wi-Fi card) based on a channel number and a channel center frequency as determined or indicated by the example application processor 1310. The application processor 1310 may include, or otherwise be connected to, one of the example secure signal converter 101 or the example received signal converter 103 (e.g., depending on which device the example radio architecture is implemented in).

In some embodiments, synthesizer circuitry 1504 may be configured to generate a carrier frequency as the output frequency 1505, while in other embodiments, the output frequency 1505 may be a fraction of the carrier frequency (e.g., one-half the carrier frequency, one-third the carrier frequency). In some embodiments, the output frequency 1505 may be a LO frequency (fLO).

FIG. 1G illustrates a functional block diagram of baseband processing circuitry 1308a in accordance with some embodiments. The baseband processing circuitry 1308a is one example of circuitry that may be suitable for use as the baseband processing circuitry 1308a (FIG. 1D), although other circuitry configurations may also be suitable. Alternatively, the example of FIG. 1F may be used to implement the example BT baseband processing circuitry 1308b of FIG. 1D.

The baseband processing circuitry 1308a may include a receive baseband processor (RX BBP) 1602 for processing receive baseband signals 1509 provided by the radio IC circuitry 1306a-b (FIG. 1D) and a transmit baseband processor (TX BBP) 1604 for generating transmit baseband signals 1511 for the radio IC circuitry 1306a-b. The baseband processing circuitry 1308a may also include control logic 1606 for coordinating the operations of the baseband processing circuitry 1308a.

In some embodiments (e.g., when analog baseband signals are exchanged between the baseband processing circuitry 1308a-b and the radio IC circuitry 1306a-b), the baseband processing circuitry 1308a may include ADC 1610 to convert analog baseband signals 1609 received from the radio IC circuitry 1306a-b to digital baseband signals for processing by the RX BBP 1602. In these embodiments, the baseband processing circuitry 1308a may also include DAC 1612 to convert digital baseband signals from the TX BBP 1604 to analog baseband signals 1611.

In some embodiments that communicate OFDM signals or OFDMA signals, such as through baseband processor 1308a, the transmit baseband processor 1604 may be configured to generate OFDM or OFDMA signals as appropriate for transmission by performing an inverse fast Fourier transform (IFFT). The receive baseband processor 1602 may be configured to process received OFDM signals or OFDMA signals by performing an FFT. In some embodiments, the receive baseband processor 1602 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1D, in some embodiments, the antennas 1301 (FIG. 1D) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1301 may each include a set of phased-array antennas, although embodiments are not so limited.

Although the radio architecture 1300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 6^{th} generation mobile networks, 3GPP, long term evolution (LTE), LTE advanced, enhanced data rates for GSM Evolution (EDGE), or the like. Other embodiments may be used in various other devices, systems, and/or networks.

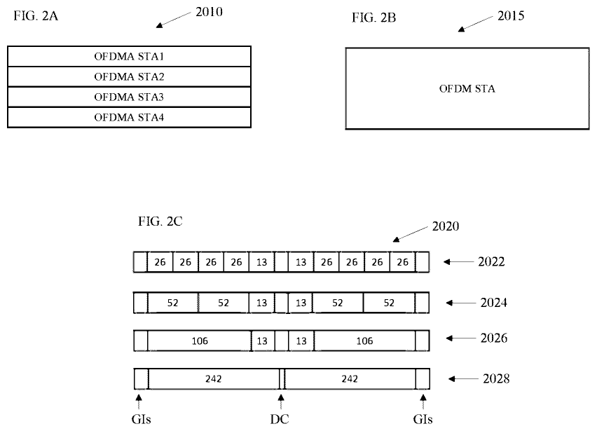

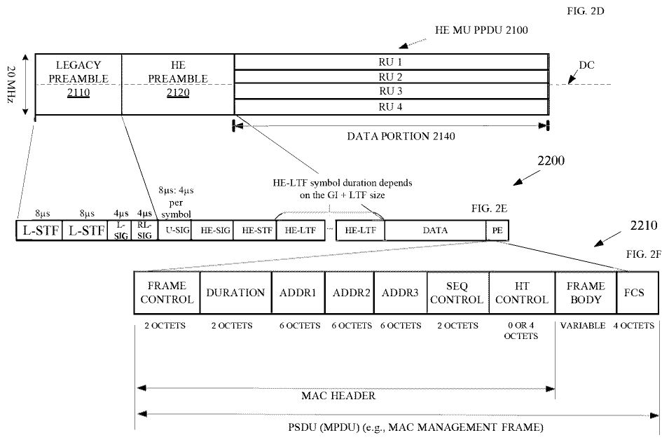

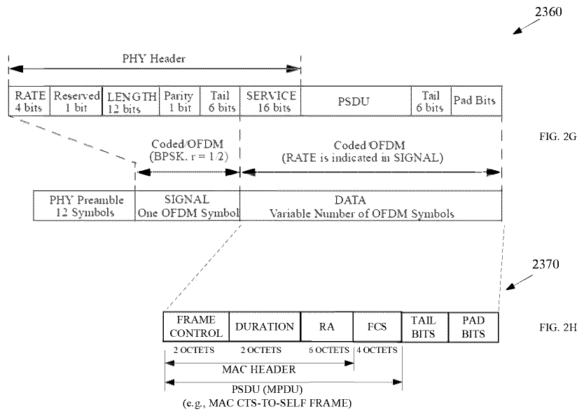

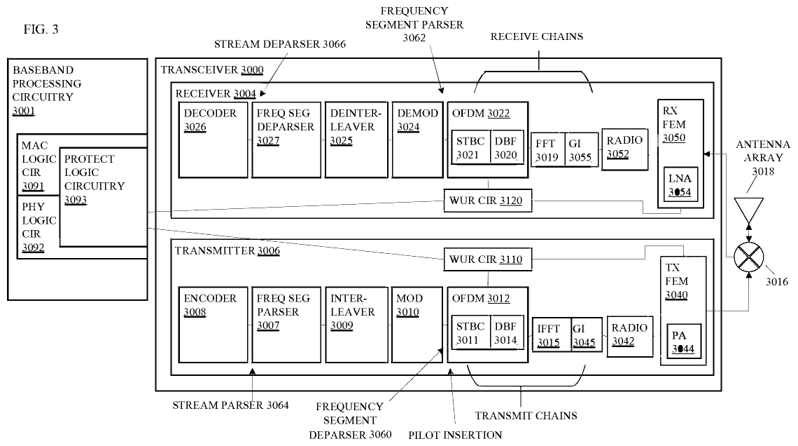

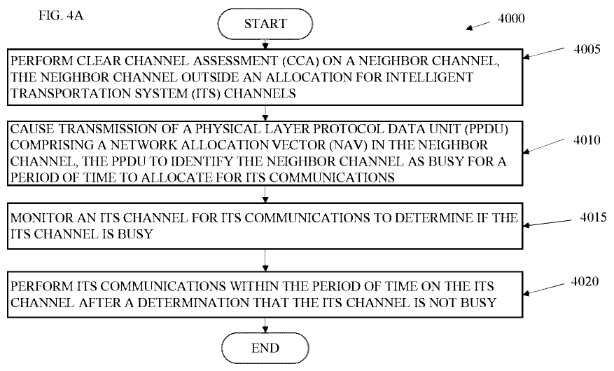

FIGS. 2A-2C illustrate embodiments of channels and subchannels (or resource units) that can facilitate multiple transmissions simultaneously such as a EHT PPDU or a HE PPDU. FIG. 2A illustrates an embodiment of transmissions 2010 between four stations and an AP on four different subchannels (or resource units) of a channel via OFDMA. Grouping subcarriers into groups of resource units is referred to as subchannelization. Subchannelization defines subchannels that can be allocated to stations depending on their channel conditions and service requirements. An OFDMA system may also allocate different transmit powers to different subchannels.

In the present embodiment, the OFDMA STA1, OFDMA STA2, OFDMA STA3, and OFDMA STA4 may represent transmissions on a four different subchannels of the channel. For instance, transmissions 2010 may represent an 80 MHz channel with four 20 MHz bandwidth PPDUs using frequency division multiple access (FDMA). Such embodiments may include, e.g., 1 PPDU per 20 MHz bandwidth, 2 PPDU in a 40 MHz bandwidth, and 4 PPDUs in an 80 MHZ bandwidth. As a comparison, FIG. 2B illustrates an embodiment of an orthogonal frequency division multiplexing (OFDM) transmission 2015 for the same channel as FIG. 2A. The OFDM transmission 2015 may use the entire channel bandwidth.

FIG. 2C illustrates an embodiment of a 20-Megahertz (MHz) bandwidth 2020 on a channel that illustrates different resource unit (RU) configurations 2022, 2024, 2026, and 2028. In OFDMA, for instance, an OFDM symbol is constructed of subcarriers, the number of which is a function of the physical layer protocol data unit (PPDU) (also referred to as the PHY frame) bandwidth. There are several subcarrier types: 1) Data subcarriers which are used for data transmission; 2) Pilot subcarriers which are utilized for phase information and parameter tracking; and 3) unused subcarriers which are not used for data/pilot transmission. The unused subcarriers are the direct current (DC) subcarrier, the Guard band subcarriers at the band edges, and the Null subcarriers.

The RU configuration 2022 illustrates an embodiment of nine RUs that each include 26 tones (or subcarriers) for data transmission including the two sets of 13 tones on either side of the DC. The RU configuration 2024 illustrates the same bandwidth divided into 5 RUs including four RUs with 52 tones and one RU with 26 tones about the DC for data transmission. The RU configuration 2026 illustrates the same bandwidth divided into 3 RUs including two RUs with 106 tones and one RU with 26 tones about the DC for data transmission. And the RU configuration 2028 illustrates the same bandwidth divided into 2 RUs including two RUs with 242 tones about the DC for data transmission. Embodiments may be capable of additional or alternative bandwidths such as such as 40 MHZ, 80 MHZ, 160 MHz, 240 MHZ, and 320 MHz.

Many embodiments support RUs of 26-tone RU, 52-tone RU, 106-tone RU, 242-tone RU, 484-tone RU, 996-tone RU, 2×996-tone RU, and 4×996-tone RU. In some embodiments, RUs that are the same size or larger than 242-tone RUs are defined as large size RUs and RUs that are smaller than 242-tones RUs are defined as small size RUs. In some embodiments, small size RUs can only be combined with small size RUs to form small size MRUs. In some embodiments, large size RUs can only be combined with large size RUs to form large size MRUs.

FIG. 2D illustrates an embodiment of a HE MU PPDU 2100 in the form of an 802.11, orthogonal frequency division multiple access (OFDMA) packet on a 20 MHz channel of, e.g., a 2.4 GHz link, a 5 GHz link, a 6 GHz link, or any other frequency. In some embodiments, the baseband processing circuitry, such as the baseband processing circuitry 1218 in FIG. 1C, may transmit a HE MU PPDU 2100 transmission on the 6 GHz carrier frequency, optionally with beamforming. In some embodiments, the HE MU PPDU 2100 may comprise a MAC association request or response frame, an MAC reassociation request or response frame, a MAC authentication frame, and/or the like.

The HE MU PPDU 2100 may comprise a legacy preamble 2110 to notify other devices in the vicinity of the source STA, such as an AP STA, that the 20 MHz channel is in use for a duration included in the legacy preamble 2110. The legacy preamble 2110 may comprise one or more short training fields (L-STFs), one or more long training fields (L-LTFs), and one or more signal fields (L-SIG and RL-SIG).

The HE MU PPDU 2100 may also comprise a HE preamble 2120 to identify a subsequent 6 GHz carrier link transmission as well as the STAs that are the targets of the transmission. Similarly, the HE preamble 2120 may comprise one or more short training fields (HE-STFs), one or more long training fields (HE-LTFs), and one or more signal fields (HE-SIG).

After the HE preamble 2120, the HE MU PPDU 2100 may comprise a data portion 2140 that includes a single user (SU) or multiple user (MU) packet. FIG. 2D illustrates the MU packet with four designated RUs. Note that the number and size of the RUs may vary between packets based on the number of target STAs and the types of payloads in the data portions 2140.

FIG. 2E depicts another embodiment of the MAC Management frame in the HE MU PPDU 2200. In some embodiments, the HE MU PPDU 2200 may be a frame format used for a DL transmission to one or more STAs. In the HE MU PPDU 2200, the MAC management frame may comprise two legacy (L) short training fields (STFs) with an 8 microseconds duration each, a legacy (L) signal (SIG) field with a four-microsecond duration, a repeated, legacy signal field (RL-SIG) with a 4-microsecond duration, and a U-SIG with 2 symbols having a 4 microsecond duration each. The HE MU PPDU 2200 format may also comprise a HE signal field (HE-SIG) with 2 symbols at 4 microseconds each, an HE STF, a number of HE-LTFs, a data field, and a packet extension (PE) field. In some embodiments, the data field may comprise may be a MAC management frame.

As illustrated in FIG. 2F, the data field of the HE MU PPDU 2200 may comprise a MAC management frame 2210 such as a MAC beacon frame, a MAC association request or response frame, a MAC reassociation request or response frame, a MAC probe request or response frame, a MAC sensing measurement request/response frame, a disassociation frame, and/or the like. The data field may comprise an MPDU (PSDU) of the MAC management frame.

In some embodiments, the MAC management frame may include a 2 octet frame control field, a 2 octet duration field, a 6 octet address 1 field, a 6 octet address 2 field, a 6 octet address 3 field, a 2 octet sequence control field, and a 0 or 4 octet high-throughput (HT) control field, in the MAC header. The MAC management frame may also include a variable length frame body field, and a 4-octet frame check sequence (FCS) field comprising a value, such as a 32-bit cyclic redundancy code (CRC), to check the validity of and/or correct preceding frame.

The Duration field may be the time, in microseconds, required to transmit the pending management frame, plus, in some embodiments, one acknowledgement (ACK) frame and one or more short interframe spaces (SIFSs). If the calculated duration includes a fractional microsecond, that value may be rounded up to the next higher integer.

The address 1 field of the MAC management frame may comprise the address of the intended receiver such as sensing responder. The address 2 field may be the address the transmitter such as a sensing initiator that transmitted the MAC management frame. The address 3 field may be the basic service set identifier (BSSID) of the sensing initiator.

The HT control field may be present in management frames as determined by the +HTC subfield of the frame control field. The frame body may include one or more fields and/or elements.

FIGS. 2G-H illustrates an example of a PPDU 2360 with a MAC management frame that may be transmitted by an AP MLD to a non-AP MLD, or vice vera. In FIG. 2G, the PPDU 2460 format may be used for a transmission of a control frame such as a ready-to-send (RTS) frame, a clear-to-send (CTS) frame, or a CTS-to-self frame.

The PPDU 2460 format may comprise an OFDM PHY preamble, an OFDM PHY header, a PSDU, tail bits, and pad bits. The PHY header may contain the following fields: length, rate, a reserved bit, an even parity bit, and the service field. in terms of modulation, the length, rate, reserved bit, and parity bit (with 6 zero tail bits appended) may constitute a separate single OFDM symbol, denoted signal, which is transmitted with the combination of BPSK modulation and a coding rate of R=1/2.

The PSDU (with 6 zero tail bits and pad bits appended), denoted as data, may be transmitted at the data rate described in the rate field and may constitute multiple OFDM symbols. The tail bits in the signal symbol may enable decoding of the rate and length fields immediately after reception of the tail bits. The rate and length fields may be required for decoding the data field of the PPDU.

In FIG. 2H, the data field of the PPDU may comprise an MPDU such as a MAC control frame 2370 such as a RTS frame, a CTS frame, or a CTS-to-self frame. The MAC control frame 2370 may include a 2-octet frame control field, a 2-octet duration field (that may include a NAV), a 6 octet RA field (that mat comprise a recipient or receiver address (RA) for an AP STA), and a 4 octet frame check sequence field comprising a value, such as a 32-bit CRC, to check the validity of and/or correct preceding frame.

FIG. 3 depicts an embodiment of an apparatus to generate, transmit, receive, and interpret or decode PHY frames and MAC frames. The apparatus comprises a transceiver 3000 coupled with baseband processing circuitry 3001. The baseband processing circuitry 3001 may comprise a MAC logic circuitry 3091 and PHY logic circuitry 3092 as well as protect logic circuitry 3093. The protect logic circuitry 3093 may perform the functionality discussed herein for protecting ITS channels as discussed above. In other embodiments, the baseband processing circuitry 3001 may be included on the transceiver 3000.

The MAC logic circuitry 3091 and PHY logic circuitry 3092 may comprise code executing on processing circuitry of a baseband processing circuitry 3001; circuitry to implement operations of functionality of the MAC or PHY; or a combination of both. In the present embodiment, the MAC logic circuitry 3091 and PHY logic circuitry 3092 may comprise protect logic circuitry 3093 to protect ITS channels as discussed herein.

The MAC logic circuitry 3091 may determine a frame such as a MAC management frame and the PHY logic circuitry 3092 may determine the physical layer protocol data unit (PPDU) by prepending the frame, also called a MAC protocol data unit (MPDU), with a physical layer (PHY) preamble for transmission of the MAC management frame via the antenna array 3018. The PHY logic circuitry 3092 may cause transmission of the MAC management frame in the PPDU.

The transceiver 3000 comprises a receiver 3004 and a transmitter 3006. Embodiments have many different combinations of modules to process data because the configurations are deployment specific. FIG. 3 illustrates some of the modules that are common to many embodiments. In some embodiments, one or more of the modules may be implemented in circuitry separate from the baseband processing circuitry 3001. In some embodiments, the baseband processing circuitry 3001 may execute code in processing circuitry of the baseband processing circuitry 3001 to implement one or more of the modules.

In the present embodiment, the transceiver 3000 also includes WUR circuitry 3110 and 3120. The WUR circuitry 3110 may comprise circuitry to use portions of the transmitter 3006 (a transmitter of the wireless communications I/F such as wireless communications I/Fs 1216 and 1246 of FIG. 1C) to generate a WUR packet. For instance, the WUR circuitry 3110 may generate, e.g., an OOK signal with OFDM symbols to generate a WUR packet for transmission via the antenna array 3018. In other embodiments, the WUR may comprise an independent circuitry that does not use portions of the transmitter 3006.

Note that a MLD such as the AP MLD 1210 in FIG. 1C may comprise multiple transmitters to facilitate concurrent transmissions on multiple contiguous and/or non-contiguous carrier frequencies.

The transmitter 3006 may comprise one or more of or all the modules including an encoder 3008, a stream deparser 3066, a frequency segment parser 3007, an interleaver 3009, a modulator 3010, a frequency segment deparser 3060, an OFDM 3012, an Inverse Fast Fourier Transform (IFFT) module 3015, a GI module 3045, and a transmitter front end 3040. The encoder 3008 of transmitter 3006 receives and encodes a data stream destined for transmission from the MAC logic circuitry 3091 with, e.g., a binary convolutional coding (BCC), a low-density parity check coding (LDPC), and/or the like. After coding, scrambling, puncturing and post-FEC (forward error correction) padding, a stream parser 3064 may optionally divide the data bit streams at the output of the FEC encoder into groups of bits. The frequency segment parser 3007 may receive data stream from encoder 3008 or streams from the stream parser 3064 and optionally parse each data stream into two or more frequency segments to build a contiguous or non-contiguous bandwidth based upon smaller bandwidth frequency segments. The interleaver 3009 may interleave rows and columns of bits to prevent long sequences of adjacent noisy bits from entering a BCC decoder of a receiver.

The modulator 3010 may receive the data stream from interleaver 3009 and may impress the received data blocks onto a sinusoid of a selected frequency for each stream via, e.g., mapping the data blocks into a corresponding set of discrete amplitudes of the sinusoid, or a set of discrete phases of the sinusoid, or a set of discrete frequency shifts relative to the frequency of the sinusoid. In some embodiments, the output of modulator 3010 may optionally be fed into the frequency segment deparser 3060 to combine frequency segments in a single, contiguous frequency bandwidth of, e.g., 320 MHz. Other embodiments may continue to process the frequency segments as separate data streams for, e.g., a non-contiguous 160+160 MHz bandwidth transmission.

After the modulator 3010, the data stream(s) are fed to an OFDM 3012. The OFDM 3012 may comprise a space-time block coding (STBC) module 3011, and a digital beamforming (DBF) module 3014. The STBC module 3011 may receive constellation points from the modulator 3010 corresponding to one or more spatial streams and may spread the spatial streams to a greater number of space-time streams. Further embodiments may omit the STBC.

The OFDM 3012 impresses or maps the modulated data formed as OFDM symbols onto a plurality of orthogonal subcarriers, so the OFDM symbols are encoded with the subcarriers or tones. The OFDM symbols may be fed to the DBF module 3014. Generally, digital beam forming uses digital signal processing algorithms that operate on the signals received by, and transmitted from, an array of antenna elements. Transmit beamforming processes the channel state to compute a steering matrix that is applied to the transmitted signal to optimize reception at one or more receivers. This is achieved by combining elements in a phased antenna array in such a way that signals at particular angles experience constructive interference while others experience destructive interference.

The IFFT module 3015 may perform an inverse discrete Fourier transform (IDFT) on the OFDM symbols to map on the subcarriers. The guard interval (GI) module 3045 may insert guard intervals by prepending to the symbol a circular extension of itself. The GI module 3045 may also comprise windowing to optionally smooth the edges of each symbol to increase spectral decay.

The output of the GI module 3045 may enter the radio 3042 to convert the time domain signals into radio signals by combining the time domain signals with subcarrier frequencies to output into the transmitter front end module (TX FEM) 3040. The transmitter front end 3040 may comprise a with a power amplifier (PA) 3044 to amplify the signal and prepare the signal for transmission via the antenna array 3018. In many embodiments, entrance into a spatial reuse mode by a communications device such as a station or AP may reduce the amplification by the PA 3044 to reduce channel interference caused by transmissions.

The transceiver 3000 may also comprise duplexers 3016 connected to antenna array 3018. The antenna array 3018 radiates the information bearing signals into a time-varying, spatial distribution of electromagnetic energy that can be received by an antenna of a receiver. In several embodiments, the receiver 3004 and the transmitter 3006 may each comprise its own antenna(s) or antenna array(s).

The transceiver 3000 may comprise a receiver 3004 for receiving, demodulating, and decoding information bearing communication signals. The receiver 3004 may comprise a receiver front-end module (RX FEM) 3050 to detect the signal, detect the start of the packet, remove the carrier frequency, and amplify the subcarriers via a low noise amplifier (LNA) 3054 to output to the radio 3052. The radio 3052 may convert the radio signals into time domain signals to output to the GI module 3055 by removing the subcarrier frequencies from each tone of the radio signals.

The receiver 3004 may comprise a GI module 3055 and a fast Fourier transform (FFT) module 3019. The GI module 3055 may remove the guard intervals and the windowing and the FFT module 3019 may transform the communication signals from the time domain to the frequency domain.

The receiver 3004 may also comprise an OFDM 3022, a frequency segment parser 3062, a demodulator 3024, a deinterleaver 3025, a frequency segment deparser 3027, a stream deparser 3066, and a decoder 3026. An equalizer may output the weighted data signals for the OFDM packet to the OFDM 3022. The OFDM 3022 extracts signal information as OFDM symbols from the plurality of subcarriers onto which information-bearing communication signals are modulated.

The OFDM 3022 may comprise a DBF module 3020, and an STBC module 3021. The received signals are fed from the equalizer to the DBF module 3020. The DBF module 3020 may comprise algorithms to process the received signals as a directional transmission directed toward to the receiver 3004. And the STBC module 3021 may transform the data streams from the space-time streams to spatial streams.

The output of the STBC module 3021 may enter a frequency segment parser 3062 if the communication signal is received as a single, contiguous bandwidth signal to parse the signal into, e.g., two or more frequency segments for demodulation and deinterleaving.

The demodulator 3024 demodulates the spatial streams. Demodulation is the process of extracting data from the spatial streams to produce demodulated spatial streams. The deinterleaver 3025 may deinterleave the sequence of bits of information. The frequency segment deparser 3027 may optionally deparse frequency segments as received if received as separate frequency segment signals or may deparse the frequency segments determined by the optional frequency segment parser 3062. The decoder 3026 decodes the data from the demodulator 3024 and transmits the decoded information, the MPDU, to the MAC logic circuitry 3091.

The MAC logic circuitry 3091 may parse the MPDU based upon a format defined in the communications device for a frame to determine the particular type of frame by determining the type value and the subtype value. The MAC logic circuitry 3091 may then interpret the remainder of MPDU.

While the description of FIG. 3 focuses primarily on a single spatial stream system for simplicity, many embodiments are capable of multiple spatial stream transmissions and use parallel data processing paths for multiple spatial streams from the PHY logic circuitry 3092 through to transmission. Further embodiments may include the use of multiple encoders to afford implementation flexibility.

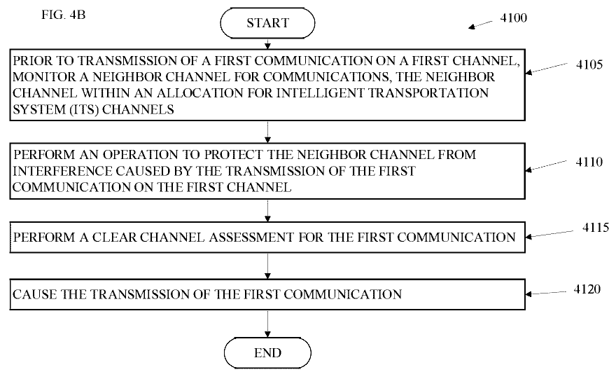

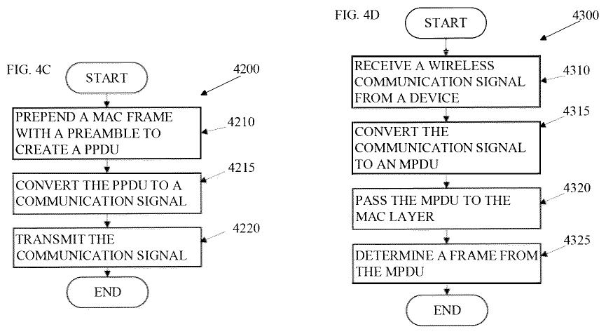

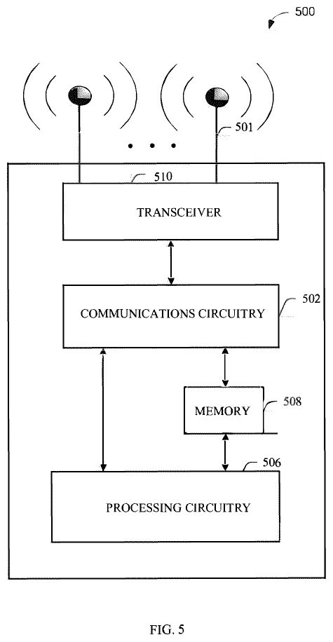

FIG. 4A depicts an embodiment of a flowchart of a process 4000 for an ITS device to implement protect logic circuitry such as the protect logic circuitry discussed in conjunction with FIGS. 1-3. At element 4005, protect logic circuitry of an ITS device may perform clear channel assessment (CCA) on a neighbor channel, the neighbor channel outside an allocation for intelligent transportation system (ITS) channels (element 4005). In some embodiments, the ITS device may proactively and preemptively cause transmission of a PPDU (element 4010) comprising a NAV on one or more neighboring, non-ITS channels, to attempt to protect the ITS channels from inter-channel emissions that might cause interference in the ITS channels. In such embodiments, the ITS device may determine whether the neighboring channels are clear and cause transmission of one or more PPDUs on the neighboring channels.

In further embodiments, protect logic circuitry of the ITS device may not cause transmission of a PPDU comprising a NAV until energy is detected in the neighbor channel that meets or exceed a threshold energy to indicate the likely presence of communications. In further embodiments, protect logic circuitry of the ITS device may receive and decode at least part of a communication in one or more of the neighbor channels to the ITS channels such as a medium access control (MAC) beacon frame, and determine to cause the transmission of the PPDU based on receipt of the MAC beacon frame. In further embodiments, the protect logic circuitry of the ITS device may detect at least a preamble of a communication in the neighbor channel, wherein detection of the preamble is based on correlation of the preamble with a known preamble or communications in the neighbor channel, and determine to cause the transmission of the PPDU based on detection of the preamble.

In some embodiments, the protect logic circuitry of the ITS device may access memory of the ITS device to obtain the PPDU for the transmission, the logic circuitry to access the memory to obtain the PPDU for the transmission, wherein the PPDU comprises a medium access control (MAC) frame, the medium access control frame comprising the NAV for a duration that is a predetermined period of time. The predetermined period of time may comprise a period of time that is typical or greater than a typical communication exchange between ITS devices for ITS communications. For instance, ITS devices may perform a communication exchange including an initial communication and an acknowledgement communication or an initial communication that is a request for information, a response to the request for information and an acknowledgement of receipt of the response to the request for information. The predetermined period of time for the duration of the NAV in the PPDU may take into account such exchanges as well as, in some embodiments, other follow-up exchanges based on a failure to receive part or all of one or more of the communications during the exchange.

In some embodiments, the ITS device may comprise a STA for Wi-Fi communications and/or a cellular interface for cellular communications. In such embodiments, the protect logic circuitry of the ITS device may further generate medium access control (MAC) frame comprising the NAV and to pass the MAC frame as a MAC service data unit (MSDU) to a physical layer (PHY) via a station management entity (SME) to cause the transmission of the PPDU. The protect logic circuitry may further generate the PPDU with the MAC frame in a data portion of the PPDU In such embodiments, the NAV may comprise a duration or time period for a specific communication exchange between the ITS device and one or more other ITS devices. In some embodiments, the PPDU may comprise a MAC frame such as a control frame. The control frame may comprise an RTS, a CTS, or a CTS-to-self. For example, in some embodiments, the ITS device may transmit an RTS and a second ITS device that is part of the communication exchange may transmit a CTS on one or more of the neighboring channels to potentially communicate the NAV to non-ITS devices on neighboring channels that did not receive the RTS. In still other embodiments, both each ITS device involved in an ITS communication exchange may cause transmission of CTS-to-self PPDUs on one or more of the neighboring channels. Note that the CTS-to-self PPDU may advantageously cause devices on each of the one or more neighbor channels to not transmit in the neighbor channels until after the expiration of the NAV whereas a failure to detect a CTS responsive to an RTS by one or more of the devices on the neighbor channels may allow some devices to determine that the communication exchange is not occurring.

After causing transmission of the PPDU with the NAV, the ITS device may monitor an ITS channel for its communications to determine if the ITS channel is busy (element 4015) and, after a determination that the ITS channel is not busy, perform the ITS communications within the period of time or NAV on the ITS channel (element 4020).

FIG. 4B depicts another embodiment of a flowchart of a process 4100 by a non-ITS device such as a Wi-Fi device or a cellular device to implement protect logic circuitry such as the protect logic circuitry discussed in FIGS. 1-3. At element 4105, prior to transmission of a first communication on a first channel, monitor a neighbor channel for communications, the neighbor channel within an allocation for intelligent transportation system (ITS) channels (element 4105). The protect logic circuitry of, e.g., a STA may perform energy detection on one or more or all the ITS channels prior to causing transmission of a communication on a neighbor channel of the ITS channels. The neighbor channels may, in some embodiments, comprise adjacent channels as shown in FIG. 1B or similar channel arrangement in other frequency bands. In some embodiments, the neighbor channels may comprise not only adjacent channels as shown in FIG. 1B or similar channel arrangement in other frequency bands, but also other channels that may cause energy emissions into the ITS channels. In some embodiments, other channels that are also considered neighbor channels may include communications that may cause energy emissions into the ITS channels at a predetermined power density threshold or above. For instance, even a “neighbor channel” located on a very different frequency range (for example in mmWave or THz bands) may qualify. In some embodiments, a “neighbor channel” may include predetermined communications on a channel for which “a communication in the neighbor channel creates a sufficiently high level of interference and/or noise in the considered intelligent transportation system (ITS) channels such that intelligent transportation system (ITS) channel communication is negatively affected or impacted (for example, Bit Error Rate or Packet Error Rate are noticeably/significantly degraded due to the interference/noise). This interference/noise may be known to cause interference or noise by out-of-band radiation of the communication in a neighbor channel of one or more of the ITS channels or through other effects (including nonlinearity effects, etc.). In some embodiments, the known negative affect or impact on ITS communications may meet a threshold of interference in at least one of the ITS channels. In some embodiments, predetermined communications on the neighbor channels may create a measurable interference in one or more ITS channels, the measurable interference being at or above a threshold of interference known to degrade or negatively affect ITS communications on one or more of the ITS channels. Note that ITS communications, in some embodiments, may use a communication protocol that may be one or more of the following: Cellular vehicle-to-everything (C-V2X) (in US and Europe), ITS-G5 (a standard developed by the European Telecommunications Standards Institute (ETSI) to implement V2X services also known as IEEE 802.11p in Europe and possibly other regions), dedicated short-range communications (DSRC) (IEEE 1609 and SAE J2735 in US and possibly other regions), and/or the like.

After determining the existence of communications in one or more neighboring ITS channels, the protect logic circuitry of the STA may perform an operation to protect the neighbor channel from interference caused by the transmission of the first communication on the first channel (element 4110). For instance, the STA may reduce the maximum allowable transmission power for communications in one or more neighbor channels and/or allocate different channels for communications currently allocated in neighbor channels, wherein the different channels are more distant (in frequency span) from the ITS channels than the neighbor channels. In some embodiments, the STA may pause or delay communications in the neighbor channels of the ITS channels until a predetermined period of time after communications are no longer detected in the ITS channels. In still further embodiments, the STA may reduce a bandwidth of communications within one or more neighbor channels of the ITS channels. Note that in such embodiments, the ITS channels may be known to the non-ITS devices such as Wi-Fi devices, cellular devices, or other such devices discussed herein.

After performing the operation to protect the ITS channels, the STA may perform a clear channel assessment for the first communication (element 4115) and after a determination that the first channel is clear, the STA may cause the transmission of the first communication (element 4120).

FIGS. 4C-D depict embodiments of flowcharts 4200 and 4300 to transmit, receive, and interpret communications with a frame. Referring to FIG. 4C, the flowchart 4200 may begin with receiving a multi-user (MU) frame from the wireless communications I/F 1216 of the AP MLD 1210 by the wireless communications I/Fs MLD 1296 as shown in FIG. 1C. The MAC logic circuitry, such as the MAC logic circuitry 3091 in FIG. 3, of the MLD 1296 may operate in conjunction with protect logic circuitry 3093 to generate a frame to transmit to the AP MLD 1210 change a communication channel for communications, reduce transmission power for communications, and/or reduce a bandwidth for communications, and may pass the frame as an MAC protocol data unit (MPDU) to a PHY logic circuitry such as the PHY logic circuitry 3092 in FIG. 3 as a PSDU to include in a PHY frame. The PHY logic circuitry may also encode and transform the PSDU into OFDM symbols for transmission to the AP MLD 1210. The PHY logic circuitry may generate a preamble to prepend the PHY service data unit (PSDU) (the MPDU) to form a PHY protocol data unit (PPDU) for transmission (element 4210).

A physical layer device such as the transmitter 3006 in FIG. 3 or the wireless network interface 1216 in FIG. 1C may convert the PPDU to a communication signal via a radio (element 4215). The transmitter may then transmit the communication signal via the antenna coupled with the radio (element 4220).

Referring to FIG. 4D, the flowchart 4300 begins with a receiver of a device such as the receiver 3004 in FIG. 3 receiving a communication signal via one or more antenna(s) such as an antenna element of antenna array 3018 (element 4310). The receiver may convert the communication signal into an MPDU in accordance with the process described in the preamble (element 4315). More specifically, the received signal is fed from the one or more antennas to a DBF such as the DBF 220. The DBF transforms the antenna signals into information signals. The output of the DBF is fed to OFDM such as the OFDM 3022 in FIG. 3. The OFDM extracts signal information from the plurality of subcarriers onto which information-bearing signals are modulated. Then, the demodulator such as the demodulator 3024 demodulates the signal information via, e.g., BPSK, 16-QAM (quadrature amplitude modulation), 64-QAM, 256-QAM, 1024-QAM, or 4096-QAM with a forward error correction (FEC) coding rate (1/2, 2/3, 3/4, or 5/6). And the decoder such as the decoder 3026 decodes the signal information from the demodulator via, e.g., BCC or LDPC, to extract the MPDU and pass or communicate the MPDU to MAC layer logic circuitry such as MAC logic circuitry 3091 (element 4320).

When received at the MAC layer circuitry, the MPDU may be a MAC Service Data Unit (MSDU). The MAC logic circuitry in conjunction with protect logic circuitry may determine frame field values from the MSDU (MPDU from PHY) (element 4325) such as the management frame fields in the management frame shown in FIG. 2F. For instance, the MAC logic circuitry may determine frame field values such as the type and subtype field values to determine that the MAC frame is the management frame and, more specifically, an association request frame, a reassociation request frame, an association response frame, a reassociation response frame, a probe request frame, and/or a probe response frame.

FIG. 5 shows a functional diagram of an exemplary communication station 500, in accordance with one or more example embodiments of the present disclosure. In one embodiment, FIG. 5 illustrates a functional block diagram of a communication station that may be suitable for use as a base station 1005 (FIG. 1A), a user device 1028 (FIG. 1A), or an ITS device 1025 in accordance with some embodiments. The communication station 500 may also be suitable for use as other user device(s) 1020 such as the user devices 1024 and/or 1026. The user device 1028 may include, e.g., a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in the above figures, diagrams, and flows.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device.

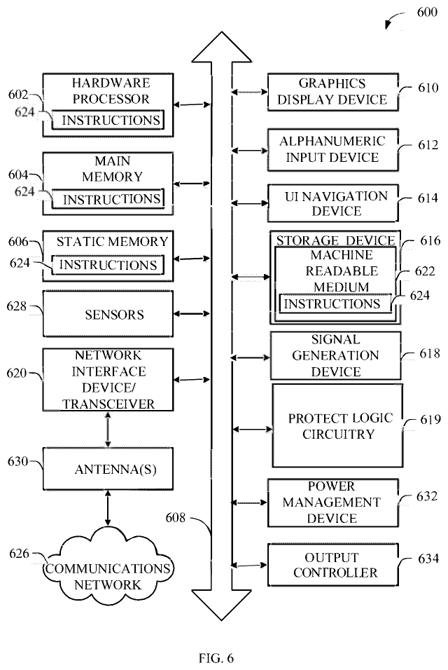

FIG. 6 illustrates a block diagram of an example of a machine 600 or system upon which any one or more of the techniques (e.g., methodologies) discussed herein may be performed. For instance, the machine may comprise a base station such as the base station 1005, ITS devices 1024, 1025, and 1026, and/or one of the user device(s) 1020 shown in FIG. 1A. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a non-AP MLD or an AP MLD in network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as link management. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via one or more interlinks (e.g., buses or high-speed interconnects) 608. Note that the single set of interlinks 608 may be representative of the physical interlinks in some embodiments but is not representative of the physical interlinks 608 in other embodiments. For example, the main memory 604 may couple directly with the hardware processor 602 via high-speed interconnects or a main memory bus. The high-speed interconnects typically connect two devices, and the bus is generally designed to interconnect two or more devices and include an arbitration scheme to provide fair access to the bus by the two or more devices.

The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), a protect logic circuitry 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor such as the baseband processing circuitry 1218 and/or 1248 shown in FIG. 1C. The baseband processor may be configured to generate corresponding baseband signals. The baseband processor may further include physical layer (PHY) and medium access control layer (MAC) circuitry and may further interface with the hardware processor 602 for generation and processing of the baseband signals and for controlling operations of the main memory 604, the storage device 616, and/or the protect logic circuitry 619. The baseband processor may be provided on a single radio card, a single chip, or an integrated circuit (IC).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The protect logic circuitry 619 may carry out or perform any of the operations and processes in relation to protection of ITS channels (e.g., flowchart of process 4000 shown in FIG. 4A and flowchart of process 4100 shown in FIG. 4B) described and shown herein. It is understood that the above are only a subset of what the protect logic circuitry 619 may be configured to perform and that other functions included throughout this disclosure may also be performed by the protect logic circuitry 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

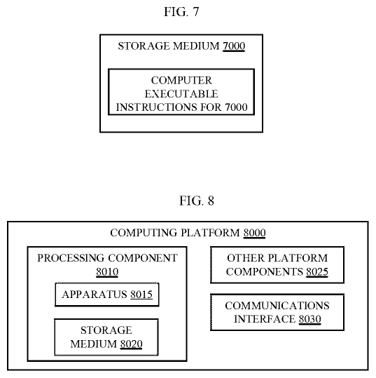

FIG. 7 illustrates an example of a storage medium 7000 to store association logic such as logic to implement the protect logic circuitry 619 shown in FIG. 6 and/or the other logic discussed herein for protection of the ITS channels. Storage medium 7000 may comprise an article of manufacture. In some examples, storage medium 7000 may include any non-transitory computer readable medium or machine-readable medium, such as an optical, magnetic or semiconductor storage. Storage medium 7000 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

FIG. 8 illustrates an example computing platform 8000 such as the MLD STAs 1210, 1290, 1292, 1294, and 1296, and ITS devices 1230 and 1298 in FIG. 1C. In some examples, as shown in FIG. 8, computing platform 8000 may include a processing component 8010, other platform components or a communications interface 8030 such as the wireless network interfaces 1216 and 1246 shown in FIG. 1C. According to some examples, computing platform 8000 may be a computing device such as a server in a system such as a data center or server farm that supports a manager or controller for managing configurable computing resources as mentioned above. In some embodiments, the computing platform may comprise a mobile device such as a smart phone, a tablet, a notebook, a laptop, a headset, a power amplifier, a television, a speaker, a video/audio streaming device, a stereo, and/or the like.

According to some examples, processing component 8010 may execute processing operations or logic for apparatus 8015 described herein. Processing component 8010 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits (ICs), application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 8020, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. While discussions herein describe elements of embodiments as software elements and/or hardware elements, decisions to implement an embodiment using hardware elements and/or software elements may vary in accordance with any number of design considerations or factors, such as desired computational rate, power levels, heat tolerances, processing cycle budget, input data rates, output data rates, memory resources, data bus speeds and other design or performance constraints.

In some examples, other platform components 8025 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., universal serial bus (USB) memory), solid state drives (SSD) and any other type of storage media suitable for storing information.

In some examples, communications interface 8030 may include logic and/or features to support a communication interface. For these examples, communications interface 8030 may include one or more communication interfaces that operate according to various communication protocols or standards to communicate over direct or network communication links. Direct communications may occur via use of communication protocols or standards described in one or more industry standards (including progenies and variants) such as those associated with the Peripheral Component Interconnect (PCI) Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 8000 may be part of a computing device that may be, for example, a server, a server array or server farm, a web server, a network server, an Internet server, a workstation, a mini-computer, a main frame computer, a supercomputer, a network appliance, a web appliance, a distributed computing system, multiprocessor systems, processor-based systems, or combination thereof. Accordingly, various embodiments of the computing platform 8000 may include or exclude functions and/or specific configurations of the computing platform 8000 described herein.

The components and features of computing platform 8000 may comprise any combination of discrete circuitry, ASICs, logic gates and/or single chip architectures. Further, the features of computing platform 8000 may comprise microcontrollers, programmable logic arrays and/or microprocessors or any combination of the foregoing where suitably appropriate. Note that hardware, firmware and/or software elements may be collectively or individually referred to herein as “logic”.

One or more aspects of at least one example may comprise representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that make the logic or processor.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

### Advantages of Some Embodiments

Several embodiments have one or more potentially advantages effects. For instance, protect logic circuitry may, advantageously reduce interference in one or more ITS channels from neighboring channels, proactively perform operations to reduce interference in one or more ITS channels, advantageously perform operations to protect ITS channels from interference by ITS devices with and without cooperation by non-ITS devices, and advantageously perform operations to protect ITS channels from interference by non-ITS devices with and without cooperation by ITS devices.

### Examples of Further Embodiments

The following examples pertain to further embodiments. Specifics in the examples may be used anywhere in one or more embodiments.

Example 1 is an apparatus comprising a memory; and logic circuitry of a first device coupled with the memory to communicate via an intelligent transportation system (ITS) channel, the logic circuitry to perform clear channel assessment (CCA) on a neighbor channel, the neighbor channel outside an allocation for ITS channels; cause transmission of a physical layer protocol data unit (PPDU) comprising a network allocation vector (NAV) in the neighbor channel, the PPDU to identify the neighbor channel as busy for a period of time to allocate for ITS communications; monitor the ITS channel for ITS communications to determine if the ITS channel is busy; and perform ITS communications within the period of time on the ITS channel after a determination that the ITS channel is not busy. In Example 2, the apparatus of claim 1, the logic circuitry comprising baseband processing circuitry and further comprising a radio coupled with the baseband processing circuitry, and one or more antennas coupled with the radio to cause the transmission of the PPDU. In Example 3, the apparatus of claim 1, the logic circuitry to further perform energy detection in one or more neighbor channels, the one or more neighbor channels comprising the neighbor channel, wherein predetermined communications on the neighbor channels create a measurable interference in one or more ITS channels, the measurable interference being at or above a threshold of interference known to degrade or negatively affect ITS communications on one or more of the ITS channels. In Example 4, the apparatus of claim 3, the logic circuitry to further to compare energy detected in the one or more neighbor channels to a threshold energy, determine that the energy detected in the neighbor channel indicates that a communication occurs on the neighbor channel, and determine to cause the transmission of the PPDU based on the energy detected being equal to or greater than the threshold. In Example 5, the apparatus of claim 1, the logic circuitry to further receive and decode at least part of a communication in the neighbor channel, wherein the communication in the neighbor channel comprises a medium access control (MAC) beacon frame, and determine to cause the transmission of the PPDU based on receipt of the MAC beacon frame. In Example 6, the apparatus of claim 1, the logic circuitry to further detect at least a preamble of a communication in the neighbor channel, wherein detection of the preamble is based on correlation of the preamble with a known preamble or communications in the neighbor channel, and determine to cause the transmission of the PPDU based on detection of the preamble. In Example 7, the apparatus of claim 1, wherein the memory comprises the PPDU for the transmission, the logic circuitry to access the memory to obtain the PPDU for the transmission, wherein the PPDU comprises a medium access control (MAC) frame, the medium access control frame comprising the NAV and wherein the period of time is a predetermined period of time. In Example 8, the apparatus of claim 1, the logic circuitry to further generate medium access control (MAC) frame comprising the NAV and to pass the MAC frame as a MAC service data unit (MSDU) to a physical layer (PHY) via a station management entity (SME) to cause the transmission of the PPDU. In Example 9, the apparatus of claim 8, the logic circuitry to further generate the PPDU with the MAC frame in a data portion of the PPDU. In Example 10, the apparatus of claim 8, wherein the MAC frame comprises a clear-to-send-to-self (CTS-to-self) frame or another control frame comprising the NAV in a duration field of the MAC frame.

Example 11 is a non-transitory computer-readable medium, comprising instructions, which when executed by a processor, cause the processor to perform operations to communicate via an intelligent transportation system (ITS) channel, the operations to perform clear channel assessment (CCA) on a neighbor channel, the neighbor channel outside an allocation for ITS channels; cause transmission of a physical layer protocol data unit (PPDU) comprising a network allocation vector (NAV) in the neighbor channel, the PPDU to identify the neighbor channel as busy for a period of time to allocate for ITS communications; monitor the ITS channel for ITS communications to determine if the ITS channel is busy; and perform ITS communications within the period of time after a determination that the ITS channel is not busy. In Example 12, the non-transitory computer-readable medium of claim 11, the operations to further perform energy detection in one or more neighbor channels, the one or more neighbor channels comprising the neighbor channel and to compare energy detected in the one or more neighbor channels to a threshold energy, determine that the energy detected in the neighbor channel indicates that a communication occurs on the neighbor channel, and determine to cause the transmission of the PPDU based on the energy detected being equal to or greater than the threshold. In Example 13, the non-transitory computer-readable medium of claim 11, the operations to further receive and decode at least part of a communication in the neighbor channel, wherein the communication in the neighbor channel comprises a medium access control (MAC) beacon frame, and determine to cause the transmission of the PPDU based on receipt of the MAC beacon frame. In Example 14, the non-transitory computer-readable medium of claim 11, the operations to further to detect at least a preamble of a communication in the neighbor channel, wherein detection of the preamble is based on correlation of the preamble with a known preamble or communications in the neighbor channel, and determine to cause the transmission of the PPDU based on detection of the preamble.

Example 15 is an apparatus comprising a memory; and logic circuitry of a first device coupled with the memory to prior to transmission of a first communication on a first channel, monitor a neighbor channel for communications, the neighbor channel within an allocation for intelligent transportation system (ITS) channels; perform an operation to protect the neighbor channel from interference caused by the transmission of the first communication on the first channel; perform a clear channel assessment for the first communication; and cause the transmission of the first communication. In Example 16, the apparatus of claim 15, the logic circuitry comprising baseband processing circuitry and further comprising a radio coupled with the baseband processing circuitry, and one or more antennas coupled with the radio to cause the transmission of the first communication. In Example 17, the apparatus of claim 15, the logic circuitry to monitor the neighbor channel by performance of energy detection in the neighbor channel, detection of a preamble on the neighbor channel, or reception of and decoding a communication on the neighbor channel, communications on the first channel being known to negatively impact ITS communications on the neighbor channel. In Example 18, the apparatus of claim 15, the operation to delay the transmission of the first communication on the first channel for a predetermined period of time for an ITS communication to complete, for a predetermined backoff period of time, or for a period of time determined based on reception of communications on the neighbor channel. In Example 19, the apparatus of claim 15, the operation to allocate a different communication channel for the first communication and to cause the transmission of the first communication on the different channel, wherein a frequency span between the different channel and the neighbor channel is greater than a frequency span between the first channel and the neighbor channel. In Example 20, the apparatus of claim 15, the operation to allocate a reduced bandwidth for the first communication within the first channel to reduce interference between the first communication and communications on the neighbor channel, and to cause the transmission of the first communication on the reduced bandwidth of the first channel.

Example 21 is a method to perform the actions described in any one of claims 1-20.

Example 22 is an apparatus comprising means for performing the method of claim 21.

Example 22 is a system comprising means for performing the actions described in any one of claims 1-20.

What is claimed is:

1. An apparatus comprising:
a memory; and
logic circuitry of a first device coupled with the memory to communicate via an intelligent transportation system (ITS) channel, the logic circuitry to:
perform clear channel assessment (CCA) on a neighbor channel, the neighbor channel outside an allocation for ITS channels;
cause transmission of a physical layer protocol data unit (PPDU) comprising a network allocation vector (NAV) in the neighbor channel, the PPDU to identify the neighbor channel as busy for a period of time to allocate for ITS communications;
monitor the ITS channel for ITS communications to determine if the ITS channel is busy; and
perform ITS communications within the period of time on the ITS channel after a determination that the ITS channel is not busy.

2. The apparatus of claim 1, the logic circuitry comprising baseband processing circuitry and further comprising a radio coupled with the baseband processing circuitry, and one or more antennas coupled with the radio to cause the transmission of the PPDU.

3. The apparatus of claim 1, the logic circuitry to further perform energy detection in one or more neighbor channels, the one or more neighbor channels comprising the neighbor channel, wherein predetermined communications on the neighbor channels create a measurable interference in one or more ITS channels, the measurable interference being at or above a threshold of interference known to degrade or negatively affect ITS communications on one or more of the ITS channels.

4. The apparatus of claim 3, the logic circuitry to further to compare energy detected in the one or more neighbor channels to a threshold energy, determine that the energy detected in the neighbor channel indicates that a communication occurs on the neighbor channel, and determine to cause the transmission of the PPDU based on the energy detected being equal to or greater than the threshold.

5. The apparatus of claim 1, the logic circuitry to further receive and decode at least part of a communication in the neighbor channel, wherein the communication in the neighbor channel comprises a medium access control (MAC) beacon frame, and determine to cause the transmission of the PPDU based on receipt of the MAC beacon frame.

6. The apparatus of claim 1, the logic circuitry to further detect at least a preamble of a communication in the neighbor channel, wherein detection of the preamble is based on correlation of the preamble with a known preamble or communications in the neighbor channel, and determine to cause the transmission of the PPDU based on detection of the preamble.

7. The apparatus of claim 1, wherein the memory comprises the PPDU for the transmission, the logic circuitry to access the memory to obtain the PPDU for the transmission, wherein the PPDU comprises a medium access control (MAC) frame, the medium access control frame comprising the NAV and wherein the period of time is a predetermined period of time.

8. The apparatus of claim 1, the logic circuitry to further generate medium access control (MAC) frame comprising the NAV and to pass the MAC frame as a MAC service data unit (MSDU) to a physical layer (PHY) via a station management entity (SME) to cause the transmission of the PPDU.

9. The apparatus of claim 8, the logic circuitry to further generate the PPDU with the MAC frame in a data portion of the PPDU.

10. The apparatus of claim 8, wherein the MAC frame comprises a clear-to-send-to-self (CTS-to-self) frame or another control frame comprising the NAV in a duration field of the MAC frame.

11. A non-transitory computer-readable medium, comprising instructions, which when executed by a processor, cause the processor to perform operations to communicate via an intelligent transportation system (ITS) channel, the operations to:
perform clear channel assessment (CCA) on a neighbor channel, the neighbor channel outside an allocation for ITS channels;
cause transmission of a physical layer protocol data unit (PPDU) comprising a network allocation vector (NAV) in the neighbor channel, the PPDU to identify the neighbor channel as busy for a period of time to allocate for ITS communications;
monitor the ITS channel for ITS communications to determine if the ITS channel is busy; and
perform ITS communications within the period of time after a determination that the ITS channel is not busy.

12. The non-transitory computer-readable medium of claim 11, the operations to further perform energy detection in one or more neighbor channels, the one or more neighbor channels comprising the neighbor channel and to compare energy detected in the one or more neighbor channels to a threshold energy, determine that the energy detected in the neighbor channel indicates that a communication occurs on the neighbor channel, and determine to cause the transmission of the PPDU based on the energy detected being equal to or greater than the threshold.

13. The non-transitory computer-readable medium of claim 11, the operations to further receive and decode at least part of a communication in the neighbor channel, wherein the communication in the neighbor channel comprises a medium access control (MAC) beacon frame, and determine to cause the transmission of the PPDU based on receipt of the MAC beacon frame.

14. The non-transitory computer-readable medium of claim 11, the operations to further to detect at least a preamble of a communication in the neighbor channel, wherein detection of the preamble is based on correlation of the preamble with a known preamble or communications in the neighbor channel, and determine to cause the transmission of the PPDU based on detection of the preamble.

15. An apparatus comprising:
a memory; and
logic circuitry of a first device coupled with the memory to:
prior to transmission of a first communication on a first channel, monitor a neighbor channel for communications, the neighbor channel within an allocation for intelligent transportation system (ITS) channels;
perform an operation to protect the neighbor channel from interference caused by the transmission of the first communication on the first channel;
perform a clear channel assessment for the first communication; and
cause the transmission of the first communication.

16. The apparatus of claim 15, the logic circuitry comprising baseband processing circuitry and further comprising a radio coupled with the baseband processing circuitry, and one or more antennas coupled with the radio to cause the transmission of the first communication.

17. The apparatus of claim 15, the logic circuitry to monitor the neighbor channel by performance of energy detection in the neighbor channel, detection of a preamble on the neighbor channel, or reception of and decoding a communication on the neighbor channel, communications on the first channel being known to negatively impact ITS communications on the neighbor channel.

18. The apparatus of claim 15, the operation to delay the transmission of the first communication on the first channel for a predetermined period of time for an ITS communication to complete, for a predetermined backoff period of time, or for a period of time determined based on reception of communications on the neighbor channel.

19. The apparatus of claim 15, the operation to allocate a different communication channel for the first communication and to cause the transmission of the first communication on the different channel, wherein a frequency span between the different channel and the neighbor channel is greater than a frequency span between the first channel and the neighbor channel.

20. The apparatus of claim 15, the operation to allocate a reduced bandwidth for the first communication within the first channel to reduce interference between the first communication and communications on the neighbor channel, and to cause the transmission of the first communication on the reduced bandwidth of the first channel.
